(19) United States
(12) Patent Application Publication
(10) Pub. No.: US 2026/0153909 A1
(43) Pub. Date: Jun. 4, 2026

(54) Reconfigurable Electronic Device

(71) Applicant: Zepp, Inc., Milpitas, CA (US)

(72) Inventors: Wang Huang, Milpitas, CA (US); Chunlin Li, Shenzhen (CN); Mingbao Shao, Shenzhen (CN); Bo Zeng, Hefei (CN); Aijun Zou, Shenzhen (CN); Tongchun Li, Shenzhen (CN); Kaile Bai, Shenzhen (CN)

(21) Appl. No.: 19/373,065

(22) Filed: Oct. 29, 2025

Related U.S. Application Data
(63) Continuation-in-part of application No. 19/007,063, filed on Dec. 31, 2024.
(60) Provisional application No. 63/741,555, filed on Jan. 3, 2025.

(30) Foreign Application Priority Data
Dec. 3, 2024 (CN) 202411764076.1
Dec. 3, 2024 (CN) 202422972561.X

(51) Int. Cl. G06F 1/16; H04N 23/68; H04N 23/695

(52) U.S. Cl. CPC G06F 1/1681; G06F 1/1616; G06F 1/1686; G06F 1/1688; H04N 23/6812; H04N 23/695

(57) ABSTRACT

A reconfigurable electronic device including a housing reconfigurable between an unfolded configuration and a folded configuration about a folding axis, comprising: a first housing portion having a first surface and at least one camera disposed at the first surface, wherein the first surface is free of a display, a second housing portion hingeably coupled to the first housing portion about the folding axis. The device may include a connector disposed between the first and second housing portions, the connector comprising a motorized rotating-shaft assembly configured to effect coordinated rotation of the first and second housing portions about the folding axis between the unfolded configuration and the folded configuration, wherein, in the folded configuration, the second housing portion overlies at least part of the first surface to physically occlude the at least one camera.

### CROSS-REFERENCE TO RELATED APPLICATIONS

This application claims the benefit of and priority to Chinese Application No. 202411764076.1, filed on Dec. 3, 2024, and Chinese Application No. 202422972561.X, filed on Dec. 3, 2024, and claims the benefit under 35 U.S.C. § 119(e) of U.S. Provisional Ser. No. 63/741,555 , filed Jan. 3, 2025, the entire contents of all of which are hereby incorporated by reference. In addition, the application is a continuation-in-part of U.S. patent application Ser. No. 19/007,063, filed Dec. 31, 2024, which claims priority to Chinese Application No. 202411764076.1, filed on Dec. 3, 2024, and Chinese Application No. 202422972561.X, filed on Dec. 3, 2024, the entire contents of all of which are hereby incorporated by reference.

### TECHNICAL FIELD

This application relates to electronic devices, and in particular, to a reconfigurable electronic device.

### BACKGROUND

Modern technologies have provided users with a growing selection of electronic devices such as portable camera devices such as action cameras. These devices are often lightweight and waterproof, which can be used in sports or outdoors settings.

Traditional designs of the portable camera devices tend to feature a camera fixed within the device body, which can be bulky and have limited shooting angles. Users are often required to manually adjust the camera position to get the best angle for shooting, which can be cumbersome.

Portable electronic devices in the form of foldable electronic devices are becoming increasingly popular, particularly in the context of mobile phones, watches, tablets, smart devices, etc. Existing foldable designs, however, are either manually folded and unfolded, which can be cumbersome and dependent on the user's dexterity, or rely upon a single-shaft drive assembly that provides limited control and functionality.

### SUMMARY

Disclosed herein are implementations of methods and apparatuses for a reconfigurable electronic device.

In some aspects, the techniques described herein relate to an electronic device, including: a housing reconfigurable between an unfolded configuration and a folded configuration about a folding axis, including: a first housing portion having a first surface and at least one camera disposed at the first surface, wherein the first surface is free of a display; a second housing portion hingeably coupled to the first housing portion about the folding axis; and a connector disposed between the first and second housing portions, the connector including a motorized rotating-shaft assembly configured to effect coordinated rotation of the first and second housing portions about the folding axis between the unfolded configuration and the folded configuration, wherein, in the folded configuration, the second housing portion overlies at least a part of the first surface to physically occlude the at least one camera.

In some aspects, the techniques described herein relate to a method of operating an electronic device having a housing with first and second housing portions and a connector having a motorized rotating-shaft assembly, the method including: capturing, by at least one camera disposed at a first surface of the first housing portion, image data; and actuating the motorized rotating-shaft assembly to rotate at least one of the first housing portion and the second housing portion about a folding axis between an unfolded configuration and a folded configuration, wherein in the folded configuration, an imaging aperture of the at least one camera is physically occluded with the second housing portion.

### BRIEF DESCRIPTION OF DRAWINGS

FIG. 1 is a perspective view of an example of an electronic device in an unfolded configuration in accordance with some implementations.

FIG. 2 is a perspective view of an example of the electronic device in a folded configuration in accordance with some implementations.

FIG. 3 is a perspective view of an example of the electronic device in an intermediate configuration between the folded configuration and the unfolded configuration in accordance with some implementations.

FIG. 4A is a perspective of an example of a connector with a motorized rotating-shaft assembly in the electronic device to facilitate reconfiguration of the electronic device between the unfolded and folded configurations according to some implementations.

FIG. 4B is a perspective view of the motorized rotating-shaft assembly shown during folding of the electronic device.

FIG. 5A is a cross-sectional view of the motorized rotating-shaft assembly of FIG. 4A and illustrating the motorized rotating-shaft assembly prior to folding of the electronic device.

FIG. 5B is a cross-sectional view of the motorized rotating-shaft assembly of FIG. 4A and illustrating the motorized rotating-shaft assembly during folding of the electronic device.

FIG. 6 is an exploded perspective view of an example of a speaker unit in the electronic device according to some implementations.

FIG. 7 is an exploded perspective view of an example plate and button assembly of the electronic device according to some implementations.

FIG. 8 is a rear perspective view of an example of the electronic device in the unfolded configuration in accordance with some implementations.

FIG. 9 is a block diagram of an example of a computing device that may be used with or incorporated into the electronic device in accordance with the present teachings.

FIG. 10 is a flow diagram of an example method of operating the electronic device according to some implementations.

FIG. 11 is a sectional view of the electronic device 100 taken along line A-A of FIG. 1 according to some implementations.

FIG. 12 is a perspective view of an example motor assembly according to some implementations.

FIG. 13 is a plan view of an example synchronizing rod according to some implementations.

FIG. 14 is a partial, front, perspective view of an example of the electronic device and an accessory device detached from the electronic device.

FIG. 15 is a front, perspective view of the accessory device.

FIG. 16 is a front, perspective view of the accessory device with parts separated.

FIG. 17 is a partial, front, perspective view of the accessory device illustrating some example environmental sensors configured to measure external parameters in a vicinity of a user.

FIG. 18 is a front, perspective view of the accessory device with a front cover removed.

FIG. 19 is a front, perspective view of an example of an electronics assembly of the accessory device.

FIG. 20 is a side, plan view of the electronics assembly.

FIG. 21 is a rear, plan view of the electronics assembly.

### DETAILED DESCRIPTION

The present disclosure describes a reconfigurable electronic device that is foldable about a central axis and includes multiple housing portions coupled by a connector. The connector incorporates a motorized rotating-shaft assembly—such as a dual-axis motorized rotating-shaft assembly—that drives coordinated movement of the housing portions between an unfolded configuration, in which a surface of one housing portion exposes at least one camera for image or video capture, and a folded configuration, in which another housing portion overlies at least part of the camera surface to physically occlude the camera. In some implementations, intermediate angular positions may also be achieved, allowing the camera to be oriented at a desired angle for flexible image capture. In some implementations, the housing combines a relatively thin flat portion that contributes to a reduced folded profile with a thicker protruding portion that accommodates one or more components such as a speaker assembly or input buttons. In some implementations, a plate may overlie at least part of the protruding portion to conceal the buttons while defining acoustic outlets for sound transmission, and may pivot to provide interactive input. An array of LED strips may be arranged about the camera surface to provide illumination, status indication, notifications, alerts or visual effects.

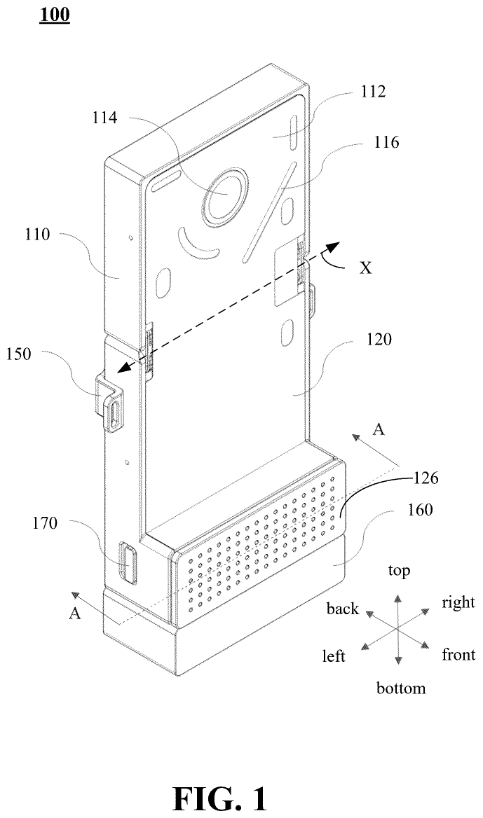

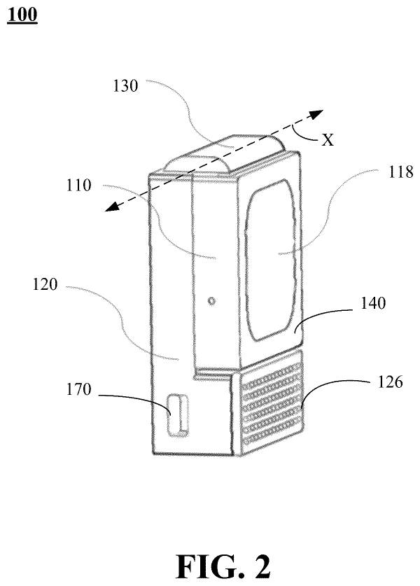

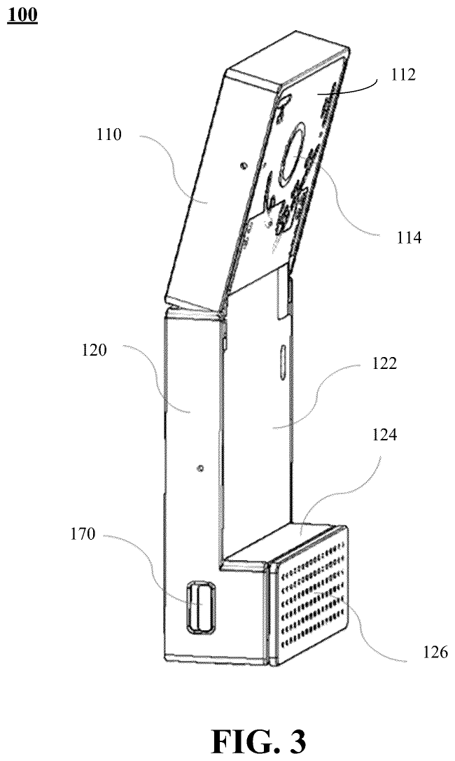

With reference now to the drawings, and in particular to FIGS. 1-3 and 8, an example electronic device 100 in accordance with the present disclosure is illustrated. The electronic device 100 includes a housing, which includes multiple housing portions coupled by a connector and is configured to fold about a folding axis. As described in greater detail below, the electronic device 100 is reconfigurable between an unfolded configuration (see, e.g., FIG. 1), in which a first housing portion 110 exposes at least one camera 114 for image or video capture, and a folded configuration (see, e.g., FIG. 2), in which a second housing portion 120 (at least partially) overlies the first housing portion 110 to physically occlude the at least one camera 114. The electronic device 100 may also assume intermediate angular positions between the unfolded and folded states (see, e.g., FIG. 3), allowing the at least one camera 114 to be oriented at a selected angle relative to the second housing portion 120.

FIG. 1 illustrates a perspective view of an example electronic device 100 in an unfolded configuration according to some implementations of this disclosure. In this example as shown, the electronic device 100 includes a first housing portion 110 and a second housing portion 120. The first housing portion 110 defines a first surface 112, and at least one camera 114 is disposed at the first surface 112. In the unfolded configuration shown in FIG. 1, the first housing portion 110 and the second housing portion 120 extend in substantially the same plane (where the angle between the first housing portion 110 and the second housing portion 120 is 180 degrees), exposing at least one the camera 114 for use. The at least one camera 114 is configured to capture image or video data. In some implementations, multiple cameras may be arranged to provide wide-angle or stereoscopic imaging.

According to FIG. 1, a LED strip module 116 comprising one or more LED strips may be disposed at the first surface 112 of the first housing portion 110. In some implementations, the LED strip module 116 may be arranged as an array of LED strips to provide illumination around the at least one camera 114, e.g., to provide uniform illumination when capturing image or video data. For example, the LED strip module 116 may be arranged circumferentially about the optical axis of the camera 114. The LED strips may be linear, arcuate, or arranged in a closed loop. The LED strips may include single-color or multicolor light sources.

In some embodiments, the LED strip module 116 may be used to provide status indicators, user prompts, abnormal or dangerous warnings, supplemental illumination, or atmosphere lighting. For example, the LED strip module 116 may be used to indicate a current battery level, provide a warning when the battery is low, or output visual notifications for incoming calls, messages, or task reminders. In another example, the LED strip module 116 may be used to automatically provide fill light in dark or low-light environments to support image capture. In yet another example, the LED strip module 116 may operate as an atmosphere light.

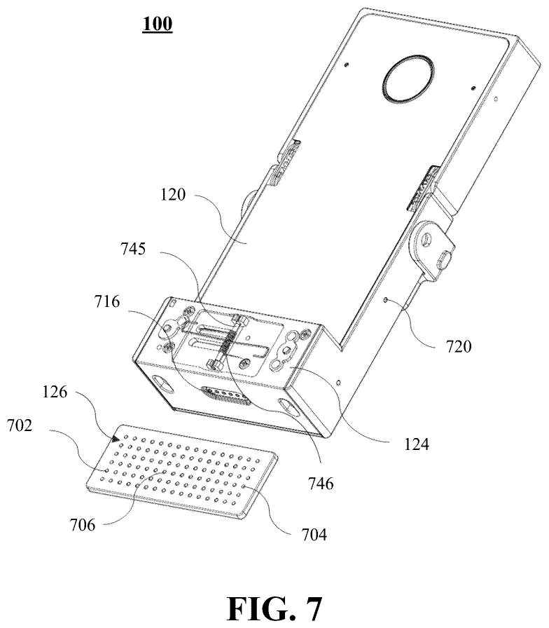

In some implementations, the LED strip module 116 may be automatically operated by the electronic device 100 to turn on or off. For example, when the electronic device 100 determines that the brightness of the image captured by the at least one camera 114 is below a threshold, at least a portion of the LED strip module 116 may be illuminated. For another example, when the electronic device 100 receives alert information (e.g., an alert for an abnormal physiological condition, an alert for receiving a new call, etc.) from another device or from an additional sensor device, at least a portion of the LED strip module 116 may be illuminated. In some other implementations, a control command can be received from a user to turn the LED strip module 116 on/off or to adjust its brightness. The control command may be received through, for example, the display 118, a hidden button (e.g., a first button 743 or a second button 744 in FIG. 7), an actuator 170 (FIGS. 1-3) or another input mechanism. Optionally, the surface of the LED strip module 116 may be covered with a protective PCI film to prevent physical damage or chemical erosion, thereby improving durability. In some implementations, the LED strips are individually addressable or controllable in groups, allowing for programmable lighting effects or selective activation.

In some implementations, the LED strips may illuminate in different colors depending on the information being conveyed. In some implementations, the LED strips may be configured to indicate the current status or physiological measurement of an individual that is associated with a wearable device. For example, the LED strips may be configured to indicate the heart rate of the individual measured by a wearable device worn by the individual. The LED strips may illuminate light of a first color when the heart rate of the individual is in a first numerical range, illuminate light of a second color when the hear rate of the individual is in a second numerical range, and illuminate light of a third color when the hear rate of the individual is in a third numerical range, for example. In this manner, an individual may be able to detect his or her approximate heart rate at a glance, even when numerical heart rate information is not displayed, or when the individual only sees the electronic device 100 through the user's peripheral vision.

In the example of FIG. 1, the first surface 112 is free of a display screen, thereby reserving the surface for imaging functionality provided by the at least one camera 114 and the LED strip module 116 without interference from a display element.

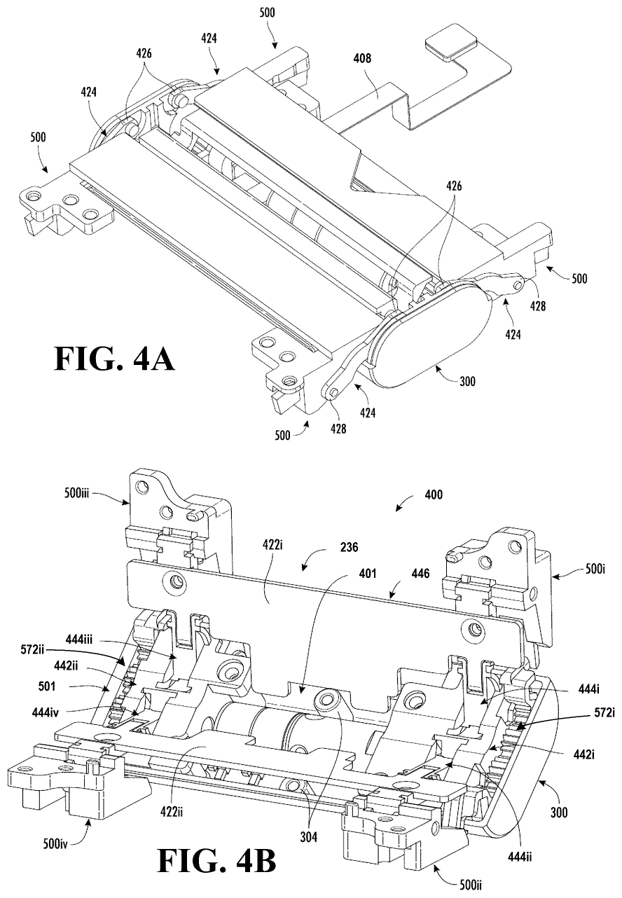

The first and second housing portions 110, 120 are movably connected such that the electronic device 100 is reconfigurable about the folding axis X between the unfolded configuration and a folded configuration (shown in FIG. 2). This reconfiguration may be accomplished in any suitable manner. For example, in some implementations, the first and second housing portions 110, 120 may be configured as discrete components connected by a connector 130 (shown in FIG. 2), such as a motorized rotating-shaft assembly 400 (shown in FIG. 4A), a mechanical hinge, or another coupling structure. For example, the second housing portion 120 may be hingeably coupled to the first housing portion 110 about the folding axis X as shown in FIG. 1. In alternative implementations, the first and second housing portions 110, 120 may be integrally formed, such as from a single piece of material, and joined by a flexible joint or living hinge that permits relative rotation.

FIG. 2 illustrates an example of the electronic device 100 in a folded configuration. In some implementations, such as the example shown in FIG. 2, the first housing portion 110 and the second housing portion 120 of the electronic device 100 is coupled by the connector 130. In this configuration, the second housing portion 120 is rotated about the folding axis X defined by the connector 130 such that the second housing portion 120 overlies the first surface 112 of the first housing portion 110. As a result, the at least one camera 114 is physically occluded by the second housing portion 120. The folded configuration thereby conceals the camera aperture from external forces, reduces the risk of scratching or damage, and enhances user privacy, while making the electronic device 100 very compact for easy carrying and storage.

In some implementations, the entire housing may be free of a display screen, e.g., both the first housing portion 110 and the second housing portion 120 are free of a display screen. In some other implementations, such as in the example shown in FIG. 2, the first housing portion 110 further defines a second surface 140 opposite the first surface 112, on which a display 118 is disposed. The display 118 may include an LCD, OLED, or other flat-panel display device, and may be touch-sensitive. The display 118 may provide live view, playback, or system control functions, among other things. In this case, the second housing portion 120 may be still free of a display element. Alternatively, the second housing portion 120 may define a third surface provided with another display. The third surface may be located on a same side of the housing as the second surface 140. In the unfolded configuration, the display 118 and the another display may be combined to form a larger display area.

In FIGS. 1-3, the second housing portion 120 further includes a plate 126 that covers at least part of a protruding portion of the second housing portion 120, which accommodates a speaker assembly. The plate 126 may conceal one or more underlying buttons while defining a series of openings to permit acoustic transmission from the speaker assembly. Alternatively, the plate 126 may conceal one or more underlying buttons, or define a series of openings to permit acoustic transmission from the speaker assembly. The plate 126 may be fixedly or pivotably mounted and also contributes to the overall aesthetic appearance of the electronic device 100 while protecting the components beneath it.

In some implementations, the electronic device 100 may further include an actuator (also referred to as folding control assembly in related applications) to receive user commands. As shown in FIGS. 1-3, an actuator 170 is disposed along a side surface of the second housing portion 120. The actuator 170 may be configured to receive user commands such as to fold or unfold the electronic device 100. In various implementations, the actuator 170 may be implemented as a button, knob, switch, slider, or touch-sensitive structure, and may generate electrical or mechanical signals that initiate reconfiguration of the first and second housing portions about the folding axis X. For example, the actuator 170 may include a groove and a rotary knob arranged in the groove, and the user commands for folding or unfolding the electronic device 100 can be received by changing the position of the rotary knob in the groove. The location of the actuator 170 is not limited to the illustrated example and may be located, for example, at a front, rear, or either side of the first housing portion 110 or the second housing portion 120 depending on ergonomic or design considerations.

It can be seen that the electronic device 100 is operable to switch between different configurations (e.g., folded and unfolded) in multiple ways. On one hand, the electronic device 100 may automatically transition between configurations based on at least one of control instructions and image data captured by the at least one camera 114. On the other hand, the electronic device 100 may be manually switched between configurations by operation of physical components such as the actuator 170. By supporting both automatic and manual switching modes, the electronic device 100 provides flexibility to accommodate different usage scenarios, thereby improving efficiency and enhancing the interactive user experience.

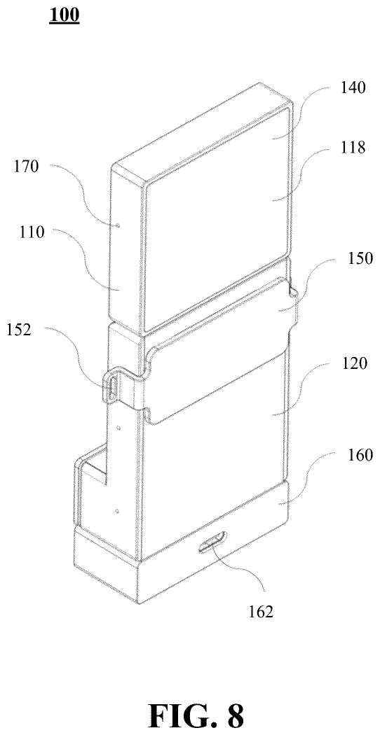

Optionally, the electronic device 100 may include an attachment structure 150 (shown in FIGS. 1 and 8) configured to enable releasable mounting of the device to an accessory or support. The attachment structure 150 may include one or more magnetic members, clips, or other engagement features suitable for wearable or portable use, thereby allowing the electronic device 100 to be removably secured in various orientations.

Additionally, as shown in FIGS. 1 and 8, the electronic device 100 may be docked with a charging base 160. The charging base 160 may include one or more electrical connectors or inductive charging elements. In some implementations, the charging base 160 is removably coupled to the second housing portion 120 for charging.

The unfolded configurations include a fully unfolded configuration (where the angle between the first housing portion 110 and the second housing portion 120 is 180 degrees) and any intermediate configurations (where the angle between the first housing portion 110 and the second housing portion 120 is more than 0 but less than 180 degrees). FIG. 3 illustrates the electronic device 100 in an intermediate configuration between the fully unfolded configuration of FIG. 1 and the folded configuration of FIG. 2. The intermediate configurations are also referred to as partially unfolded configurations. In the intermediate configuration as illustrated, the first housing portion 110 and the second housing portion 120 extend at an angle between 0 and 180 degrees relative to one another about the folding axis X, rather than fully unfolded (180 degrees) or folded (e.g., in contact with each other, 0 degree).

The intermediate configurations may occur during folding or unfolding of the electronic device 100, which allows the electronic device 100 to be reconfigured about the connector 130. For example, the angle can be selected by the electronic device 100 to reorient the at least one camera 114 toward an object of interest, as will be described below. The intermediate configuration is not limited to the illustrated angle, and the first and second housing portions 110, 120 may be positioned at a variety of different angular orientations about the folding axis X to provide multiple intermediate configurations depending on user preference or device functionality.

In some implementations, the intermediate configurations correspond to discrete desired angles stored in the memory, and a processor of the electronic device 100 can actuate the connector 130 to position the first housing portion 110 and the second housing portion 120 at a selected desired angle.

The thickness of the second housing portion 120 may be uniform, or vary across different regions of the second housing portion 120. In the example as shown in FIG. 3, the second housing portion 120 includes a flat portion 122 and a protruding portion 124, with the protruding portion 124 having a greater thickness than the flat portion 122. In some implementations, the flat portion 122 is positioned closer to the at least one camera 114 (e.g., at an upper end of the second housing portion 120), while the protruding portion 124 is located farther from the at least one camera 114 (e.g., at a lower end of the second housing portion 120). This arrangement provides a thinner profile in the imaging area while still allowing the protruding portion 124 to house components such as a speaker unit, charging circuitry, or other electronics. In some implementations, the flat portion 122 may be mechanically coupled to the first housing portion 110 through the connector 130, such as the a motorized rotating-shaft assembly (also referred to as drive assembly herein and in related applications) described further below, while the protruding portion 124 is positioned at the opposite end of the second housing portion 120.

In some implementations, the plate 126 at least partially covers the protruding portion 124. The plate 126 may define one or more acoustic outlets or a sound outlet array to enhance audio performance. In some implementations, the sound outlet array may instead, or in addition, be provided on the flat portion 122, such as covering most or all of a surface of the flat portion 122. In some implementations, the plate 126 may also conceal one or more buttons disposed beneath it, and may be mounted to pivot about a fixed shaft such that pressing one subregion actuates a corresponding button while releasing another.

As illustrated in FIG. 3, the difference in thickness between the flat portion 122 and the protruding portion 124 also facilitates a compact folded profile. During folding, the flat portion 122 rotates toward the first housing portion 110, while the protruding portion 124 moves to overlap with the first housing portion 110.

In some implementations, the thickness of the protruding portion 124 is selected to substantially equal the combined thickness of the flat portion 122 and the first housing portion 110, such that when the electronic device 100 is folded, the overall thickness of the device remains generally uniform across its width. Accordingly, in the folded configuration, the flat portion 122 faces the first housing portion 110 and the protruding portion 124 is disposed over the first housing portion 110, such that the electronic device 100 exhibits a substantially uniform overall thickness measured perpendicular to the first surface 112.

The electronic device 100 may be designed to be compact and lightweight, and convenient for carrying. For example, in some implementations, when the electronic device 100 is in the unfolded configuration, the overall length of the electronic device 100 (measured vertically as shown in FIG. 1) may be between about 80 mm and 120 mm. The width (measured laterally) may be between about 30 mm and 60 mm. The thickness of the first housing portion 110 may be between about 8 mm and 12 mm. The thickness of the flat portion 122 of the second housing portion 120 may be between about 8 mm and 12 mm. The thickness of the protruding portion 124 of the second housing portion 120 may be between about 16 mm and 24 mm.

In some implementations, the connector 130 has a thickness smaller than the thickness of the first housing portion 110. For example, the thickness of the first housing portion 110 may be about 10 mm, and the thickness of the connector 130 may be less than about 8 mm.

In some implementations, the area of the flat portion 122, which overlies and covers the at least one camera 114 of the first housing portion 110 when the electronic device 100 is folded, may be greater than the area of the protruding portion 124. In certain examples, the area of the flat portion 122 may be at least twice or more than the area of the protruding portion 124. The thicknesses of the first housing portion 110 and the flat portion 122 may be similar or different. In some implementations, the area of the flat portion 122 is the same as or slightly larger than the area of the first housing portion 110, which enhances the visual uniformity of the electronic device 100 in the folded configuration.

By designing the flat portion 122 to be relatively thin, the overall thickness of the electronic device 100 in the folded configuration can be reduced, thereby enhancing portability. Conversely, by designing the protruding portion 124 to be relatively thick, additional internal space is created to accommodate various components of the electronic device 100, such as a speaker assembly, button mechanisms, or processing circuitry. This arrangement facilitates miniaturization of the electronic device 100 without sacrificing functionality, while enabling higher levels of component integration.

FIG. 4A is a perspective of the connector 130 of the electronic device 100, which includes a motorized rotating-shaft assembly 400 (also referred to as a drive assembly 400) configured to reconfigure the electronic device 100 between the unfolded and folded configurations, according to some implementations of this disclosure. The connector 130 further includes a connector housing 300 (also referred to as chassis in related applications), and the motorized rotating-shaft assembly 400 is disposed within the connector housing 300.

The connector 130 may couple the first housing portion 110 and the second housing portion 120 such that, under the drive of the motorized rotating-shaft assembly 400, the second housing portion 120 may rotate relative to the first housing portion 110 to expose or occlude the at least one camera 114, and optionally adjust the shooting angle during use. This configuration avoids the need for frequent manual adjustments by the user, enhances convenience, and allows for more flexible and comprehensive image capture. In some implementations, the connector 130 may further facilitate bidirectional rotation of the housing portions, thereby improving the efficiency of reconfiguration.

In some implementations, the motorized rotating-shaft assembly 400 is configured to act upon each of the housing portions 110, 120, as described in further detail below, such that, during operation of the motorized rotating-shaft assembly 400, the housing portions 110, 120 articulate in concert (unison, simultaneously) during folding and unfolding of the electronic device 100. The housing portions 110, 120 can rotate in opposite directions during such operation. However, it is also possible for the housing portions 110, 120 to rotate in the same direction. The rotation angle for housing portions 110, 120 may be the same or different, which can result in more flexible shooting angles.

In some implementations, the motorized rotating-shaft assembly 400 may be configured to act upon one of the housing portions 110, 120. In such embodiments, it is envisioned that one of the housing portions 110, 120 may remain stationary while the other of the housing portions 110, 120 is movable through an angular range of motion of from 0° to 180°.

In some implementations, an angle detection sensing module may also be disposed within the connector housing 300 to sense angular displacement of the first housing portion 110 and the second housing portion 120 about the folding axis X. In some implementations, the motorized rotating-shaft assembly 400 may include the angle detection module, which may include a Hall sensor or another sensor that can perform similar functions, for measuring the angular position of the housing portion 110 and/or the angular position of the housing portion 120 via the generation of a magnetic field.

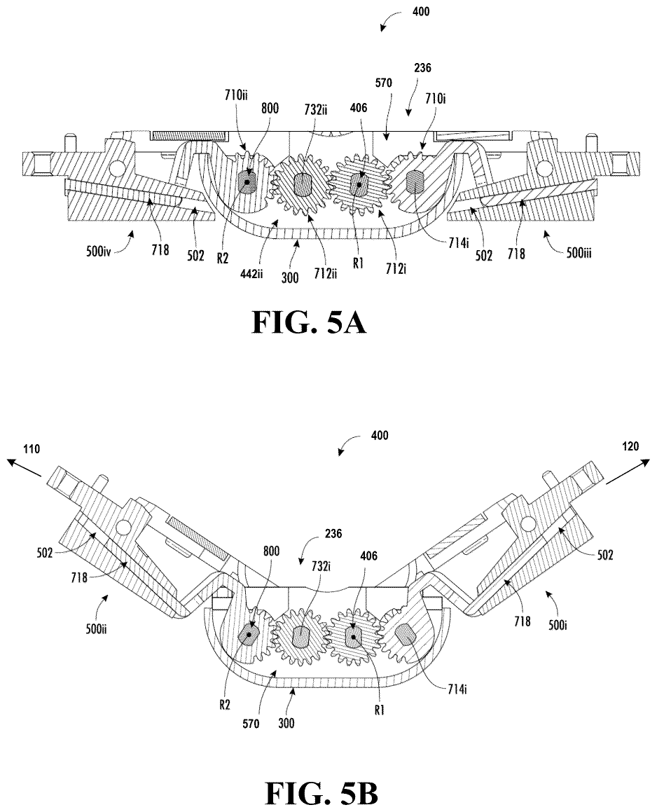

FIG. 4B is a perspective view of the motorized rotating-shaft assembly 400 during folding of the electronic device 100. The motorized rotating-shaft assembly 400 is connected (secured) to a housing of the electronic device 100 and is configured to facilitate reconfiguration of the electronic device 100 between the unfolded and folded configurations. With reference to FIGS. 5A and 5B, the motorized rotating-shaft assembly 400 defines the axes of rotation R1, R2 and includes: the connector housing 300 (also referred to as the connector housing 300); a support assembly 236; anchors 500; an (electric) motor assembly 401; a transmission 570; and a synchronizing rod 800.

As shown in FIG. 4B, the motorized rotating-shaft assembly 400 is supported within the connector housing 300 and may further include a support assembly 236 connected to the connector housing 300 and anchors 500i, 500ii. The support assembly 236 may include brackets 442, arms 444, and a platform 446. The support assembly 236 interfaces with and braces (stabilizes, reinforces, supports) the motor assembly 401, the transmission 570, and the synchronizing rod 800 and indirectly connects the connector housing 300 to the anchors 500i, 500ii, the motor assembly 401, the transmission 570, and the synchronizing rod 800. The brackets 442 are connected (secured) to the connector housing 300, e.g., via mechanical fasteners, an adhesive, etc., and span, e.g., extend across (are positioned on opposite sides of), the folding axis X (FIGS. 1-2). More specifically, the support assembly 236 includes a bracket 402i (referred to as a first bracket portion) and a bracket 402ii (referred to as a second bracket), each of which includes (defines) a plurality of apertures, among other things.

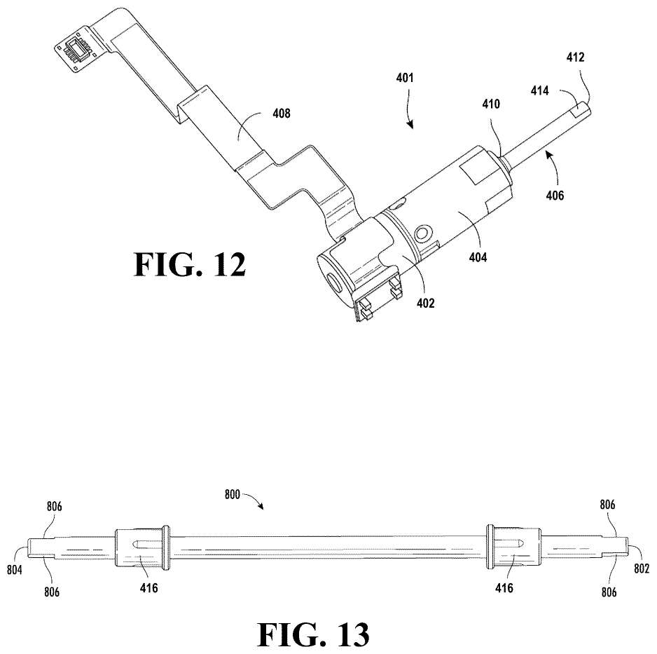

FIG. 12 is a perspective view of an example of the motor assembly 401 according to some implementations. With reference to FIGS. 4A, 4B, 5A, and 5B, the motor assembly 401 is directly connected to the transmission 570 such that power from the motor assembly 401 is delivered to the housing portions of the electronic device 100 via the transmission 570 to fold and unfold the device during reconfiguration of the electronic device 100. The motor assembly 401 includes (one or more) at least one (electric) motor 402, (one or more) at least one gearbox 404 operatively coupled to the motor(s) 402 to provide torque amplification, and may further include (one or more) at least one drive shaft 406; and a flexible printed circuit (FPC) 408.

In the illustrated implementations, the motor assembly 401 includes a single motor 402, a single gearbox 404, and a single drive shaft 406. However, implementations in which the motor assembly 401 may include multiple motors, gearboxes, and/or drive shafts are also envisioned.

The motor assembly 401 is connected (secured) to the connector housing 300 in order to further inhibit (if not entirely prevent) unintended, e.g., off-axis (eccentric) movement, e.g., roll, of the motor assembly 401 during operation of the motorized rotating-shaft assembly 400 and reconfiguration of the electronic device 100. For example, the motor assembly 401 may be connected (secured) to the connector housing 300 via a retainer, which may be secured to bosses 304 on the connector housing 300, e.g., via mechanical fasteners, an adhesive, etc.

The drive shaft 406 engages (contacts) and extends between the gearbox 404 and the transmission 570 in order to operatively, e.g., indirectly, connect the motor 402 and the gearbox 404 to the transmission 570 such that the drive shaft 406 transfers (transmits) power and torque from the motor 402, through the gearbox 404, to the transmission 570. The drive shaft 406 defines the axis of rotation R1. For example, in some implementations, the drive shaft 406 may be generally aligned with the Hall sensor, such that the drive shaft 406 and the Hall sensor are arranged in coaxial relation.

The drive shaft 406 includes an end 410 (referred to as a first end), which engages (contacts, interfaces with) the gearbox 404, and an end 412 (referred to as a second end), which engages (contacts, interfaces with) the transmission 570. The end 412 of the drive shaft 406 includes a non-circular cross-sectional configuration that defines (one or more) at least one flat surface 414, which facilitates engagement (contact) with the transmission 570 and inhibits (if not entirely prevents) relative rotation between the drive shaft 406 and the transmission 570.

In order to reduce friction during rotation, the drive shaft 406 may include (one or more) at least one bushing, which extends about and receives the drive shaft 406.

The FPC 408 extends between and electrically connects the electronic device 100 and the motor assembly 401 in order to facilitate the communication of data and/or power therebetween. For example, the FPC 408 facilitates the transmission of activation and deactivation signals to the motor assembly 401 in order to initiate and terminate reconfiguration (folding) of the electronic device 100.

FIG. 5A is a cross-sectional view of the motorized rotating-shaft assembly 400 of FIG. 4A and illustrating the motorized rotating-shaft assembly 400 prior to folding of the electronic device 100. FIG. 5B is a cross-sectional view of the motorized rotating-shaft assembly 400 of FIG. 4A and illustrating the motorized rotating-shaft assembly 400 during folding of the electronic device 100.

Referring now to FIG. 4B as well, the transmission 570 includes (first, second) transmission assemblies 572i, 572ii and directly engages (contacts, interfaces with) and extends between the anchors 500 and the motor assembly 401 in order to transfer (transmit) power and torque from the motor assembly 401 to the anchors 500 to facilitate repositioning (movement, articulation) of the anchors 500 and, thus, reconfiguration of the electronic device 100 between the folded and unfolded configurations. The transmission assemblies 572i, 572ii are spaced apart (separated) along and span, e.g., extend across (are positioned on opposite sides of), the folding axis X (FIGS. 1-2) such that the transmission assemblies 572i, 572ii extend in generally orthogonal (perpendicular) relation to the folding axis X and the axes of rotation R1, R2 (FIGS. 5A and 5B), which extend between and pass through each of the transmission assemblies 572i, 572ii.

The transmission assemblies 572i, 572ii each include first ends, which engage the anchors 500i, 500iii and are thus indirectly connected (secured) to the housing portion 110 (FIGS. 1-3, 8), and second ends, which engage the anchors 500ii, 500iv and are thus indirectly connected (secured) to the housing portion 120. More specifically, the transmission assemblies 572i, 572ii are configured such that the first ends of the transmission assembly 572i are spaced apart (separated) along an axis Y1 (referred to as a first axis), and such that the first ends of the transmission assembly 572ii are spaced apart (separated) along an axis Y2 (referred to as a second axis), wherein the axes Y1, Y2 extend in generally parallel relation to each other and in generally orthogonal (perpendicular) relation to the folding axis X (FIGS. 1-2) and the axes of rotation R1, R2 (FIGS. 5A and 5B).

The transmission assemblies 572i, 572ii each include a plurality of gears, which are oriented in generally linear arrangements along the axes Y1, Y2, respectively. More specifically, the transmission assemblies 572i, 572ii each include (first, second) torsion gears 710i, 710ii and (one or more) at least one transfer gear 712, which is positioned (located) between the torsion gears 710i, 710ii.

The torsion gears 710i, 710ii are supported by the brackets 442 such that the torsion gears 710i, 710ii are rotatable in relation thereto. More specifically, the torsion gears 710i are connected (secured) to the brackets 442 by pins 714i (FIGS. 5A and 5B), which extend into and through apertures in the brackets 442, and the torsion gears 710ii engage (contact, interface with) the synchronizing rod 800, which extends into and through apertures in the brackets 442.

The torsion gears 710i, 710ii directly engage (contact) the anchors 500 such that movement (articulation, rotation, pivoting) of the torsion gears 710i, 710ii causes corresponding movement (articulation, rotation, pivoting) of the anchors 500. More specifically, the torsion gears 710i, 710ii in the transmission assembly 572i respectively engage (contact) the anchors 500i, 500ii, and the torsion gears 710i, 710ii in the transmission assembly 572ii respectively engage (contact) the anchors 500iii, 500iv.

As seen in FIGS. 5A and 5B, transfer gear(s) 712i, 712ii are positioned (located) between the torsion gears 710i, 710ii and are supported by the brackets 442 such that the transfer gear(s) 712 are rotatable in relation thereto in concert (unison, simultaneously). More specifically, the transfer gears 712i, 712ii are positioned (located) in mating (meshing) engagement (contact) with each other and with the torsion gears 710i, 710ii, respectively such that rotation of the transfer gears 712i, 712ii causes corresponding rotation of the torsion gears 710i, 710ii and rotation of the torsion gears 710i, 710ii causes corresponding rotation of the transfer gears 712i, 712ii.

The transfer gears 712i, 712ii in the transmission assemblies 572i, 572ii, although identical, operate differently and perform disparate functions, which is a result of the inclusion of a single motor 402, a single gearbox 404, and a single drive shaft 406. More specifically, in the transmission assembly 572ii, the transfer gear 712i engages (contacts, interfaces with) the drive shaft 406, which extends through an aperture in the bracket 442ii and into an opening in the transfer gear 712i, via engagement (contact) between the flat surfaces (e.g., 414), and the transfer gear 712ii is connected (secured) to the bracket 442ii by a pin 732ii (FIG. 5A), which extends into an aperture in the bracket 442i (FIG. 4B). The transmission 570, e.g., the transmission assembly 572ii, is thus directly connected to the motor assembly 401 via the engagement of (contact between) the drive shaft 406 and the transfer gear 712i, whereby the transfer gear 712i in the transmission assembly 572ii receives power and torque directly from the motor assembly 401 and transfers (transmits) that power to the transfer gear 712ii and the torsion gears 710i, 710ii. By contrast, in the transmission assembly 572i, the transfer gears 712i, 712ii are connected (secured) to the bracket 442i by pins 732i, 732ii (FIGS. 5A and 5B), which extend into the apertures in the bracket 442i, respectively. The transfer gears 712i, 712ii in the transmission assembly 572i thus receive power and torque from the motor assembly 401 indirectly, which is facilitated by the synchronizing rod 800, as described in further detail below, whereby the motor assembly 401 is devoid of any direct connection to the transmission assembly 572i.

Although the transmission 570 is shown as including a pair of transfer gears 712i, 712ii, embodiments of the transmission 570 that include a single transfer gear 712 are also envisioned herein as are embodiments including three or more transfer gears 712, e.g., depending upon the particular configuration of the electronic device 100, the size and scale of the drive assembly 400, etc.

In some implementations, such as in the examples described above, the various gears are positioned on opposite sides of the gearbox 404, thereby distributing torque symmetrically across the folding axis X to provide balanced and stable rotation. This arrangement enables rotational power from the motor 402 to be transmitted through the gearbox 404 and distributed by the torsion gears 710i, 710ii and the transfer gears 712i, 712ii, thereby effecting coordinated rotation of the first housing portion 110 and the second housing portion 120 about the folding axis X, allowing stable torque transfer and smooth rotational motion of the first housing portion 110 and the second housing portion 120 during folding and unfolding, while also allowing the components of the motorized rotating-shaft assembly 400 to be compactly housed within the connector housing 300.

The connector housing 300 spans the folding axis X and may define mounting portions to receive fasteners and interface features to secure internal subassemblies and to couple the motorized rotating-shaft assembly 400 to the adjacent housings such as the first housing portion 110 and the second housing portion 120. A surface of the connector housing 300 may be arcuate or curved. In some implementations, when the electronic device 100 is in the folded configuration, the connector housing 300 is positioned between the first housing portion 110 and the second housing portion 120, and extends above the top surfaces of the first and second housing portion 110, 120 (see FIG. 2). In this manner, the connector housing 300 conceals and protects the internal components of the connector 130, thereby improving both the aesthetics and reliability of the electronic device 100. In alternative implementations, when the electronic device 100 is in the unfolded configuration, the connector housing 300 may be at least partially received within at least one of the first housing portion 110 or the second housing portion 120 so as to provide a more seamless and consistent overall appearance.

In addition to improving the aesthetic appearance of the connector 130, the connector housing 300 receives, shields, and protects the motor assembly 401, the transmission 570, and associated subcomponents such as the synchronizing rod 800 and the various gears such as the torsion gears 710i, 710ii and the transfer gears 712i, 712ii. The connector housing 300 may be formed of any suitable material(s) of construction, including metallic or non-metallic materials. When the electronic device 100 is in the unfolded configuration, the connector housing 300 can be concealed at least in part within at least one of the first housing portion 110 or the second housing portion 120, thereby improving the aesthetic appearance of the electronic device 100.

With reference to FIG. 4A, in some implementations, the support assembly 236 further includes connecting rods 424. Embodiments of the support assembly 236 that are devoid of the connecting rods 424 are also envisioned herein, however.

The connecting rods 424 further increases the strength (stability, rigidity) of the drive assembly 400 and the electronic device 100 and extend between and connect the connector housing 300 and the anchors 500. More specifically, the connecting rods 424 may include first ends (not shown), which are movable (rotationally, pivotably) connected (secured) to the connector housing 300, and second ends, which are movable (rotationally, pivotably) connected (secured) to the anchors 500. Connecting the anchors 500 to the connector housing 300 inhibits (if not entirely prevents) unintended movement, e.g., rattle, of the anchors 500 during operation of the drive assembly 400 and reconfiguration of the electronic device 100.

As shown in FIGS. 5A and 5B,, the drive shaft 406 extends coaxially with the folding axis X, while the synchronizing rod 800 is disposed in parallel, offset from the drive shaft 406. The synchronizing rod 800 couples the left and right portions of the transmission 570, ensuring coordinated and balanced motion of the first housing portion 110 and the second housing portion 120.

As shown in FIGS. 5A and 5B, and described below, the first housing portion 110 is repositionable (movable) in relation to the connector 130 about the axis of rotation R1 (referred to as a first axis of rotation). The second housing portion 120 is repositionable (movable) in relation to the connector 130 about the axis of rotation R2 (referred to as a second axis of rotation). As seen in FIGS. 5A and 5B, R1 is defined by the drive shaft 406, while R2 is defined by the synchronizing rod 800.

In some implementations, the first axis of rotation R1 and the second axis of rotation R2 are spaced apart from one another and are substantially parallel to the folding axis X, thereby allowing coordinated movement of the first housing portion 110 and the second housing portion 120 about the connector 130.

FIG. 13 is a plan view of an example of the synchronizing rod 800 according to some implementations. With reference now to FIGS. 5A, 5B, the synchronizing rod 800 extends between and operatively connects the first and second transmission assemblies (e.g., 502i, 502ii) to facilitate power transfer therebetween such that the transmission assemblies are operable in unison to deliver torque to the anchors (e.g., 500) during folding and unfolding of the electronic device 100.

The synchronizing rod 800 includes a first end 802 and a second (opposite) end 804 that define the axis of rotation R2, which in the illustrated example is offset from the axis of rotation R1 defined by the drive shaft 406. The axes R1 and R2 extend in generally parallel relation to the folding axis X, thereby providing balanced torque delivery.

The ends 802, 804 of the synchronizing rod 800 engage corresponding elements of the transmission assemblies 572i, 572ii (FIG. 4B) so that rotation imparted to one transmission assembly is transferred through the synchronizing rod 800 to the other. In some implementations, each end 802, 804 may mate with a gear element of the transmission assemblies (e.g., a torsion gear, a coupling gear, or another rotary member).

In this arrangement, rotation of a gear element in the second transmission assembly 572ii, for example via engagement with a transfer gear, causes corresponding rotation of the synchronizing rod 800 and thereby rotation of the corresponding gear element in the first transmission assembly 572i. This coupling ensures that both transmission assemblies deliver torque in unison to the brackets 442 (FIG. 4B), thereby maintaining balanced and synchronous folding motion of the first housing portion 110 and the second housing portion 120 about the folding axis X.

The ends 802, 804 of the synchronizing rod 800 may include non-circular cross-sectional configurations, each defining at least one flat surface 806, which facilitates engagement with gear elements of the transmission assemblies 572i, 572ii. The flat surfaces 806 are configured for mating engagement with corresponding flat surfaces defined in the gear elements so as to inhibit relative slip. Engagement between the flat surfaces 806 of the synchronizing rod 800 and the mating flats of the gear elements ensures that rotation imparted to one transmission assembly, for example the second transmission assembly 572ii, is transmitted through the synchronizing rod 800 to the first transmission assembly 572i, thereby maintaining synchronous operation of the assemblies. In some implementations, the gear elements may be torsion gears, but other rotary members may be employed.

To reduce friction during rotation, the synchronizing rod 800 includes bushings 416 disposed along its length. The bushings 416 extend about the synchronizing rod 800 and may be fabricated from low-friction polymer, bronze, or another bearing material. In some implementations, rolling-element bearings may be substituted.

In some implementations, a portion of the motorized rotating-shaft assembly 400 may be disposed within the first housing portion 110 and a portion of the motorized rotating-shaft assembly 400 may be disposed within the second housing portion 120, which can achieve a more compact design for the electronic device 100 and a smooth overall appearance.

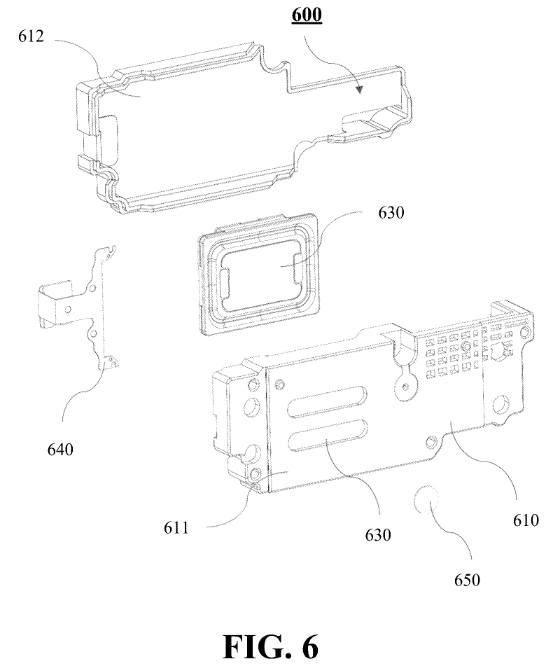

FIG. 6 is an exploded perspective view of an example of a speaker assembly 600 of the electronic device 100, according to some implementations of this disclosure. As shown in FIG. 6, the protruding portion 124 may include the speaker assembly 600. The speaker assembly 600 may include a speaker housing 610, a speaker component 630, and one or more sound apertures 650. The speaker housing 610 may further include a front shell 611 and a rear shell 612 that together define an acoustic chamber for the speaker component 630. The front shell 611 and the rear shell 612 may be formed of any suitable material, such as a polymer material, and may be fixed to the second housing portion 120 of the electronic device 100.

One or more sound apertures 650 may be defined in the speaker housing 610. In some implementations, multiple sound apertures 650 are formed and the total area of the apertures may exceed a threshold value (e.g., greater than 25 square millimeters) to improve the performance of the speaker assembly 600. In the illustrated example, the sound apertures 650 are located in the front shell 611, but the number and location of the apertures are not limited to this example.

A circuit board 640 may be disposed within the speaker housing 610 to provide electrical interconnection for the speaker component 630. In addition, balance film may be disposed on the speaker housing 610 to maintain pressure equilibrium between the inside and outside of the speaker housing 610, thereby reducing distortion and improving acoustic quality. The speaker component 630 may be mounted to the circuit board 640 inside the speaker housing 610. In some implementations, the circuit board 640 may be a flexible printed circuit (FPC) to reduce size and improve integration, although the disclosure is not limited in this regard. By providing an independent speaker assembly 600 in the electronic device 100, improved sound output may be achieved to meet user demand for audio interaction.

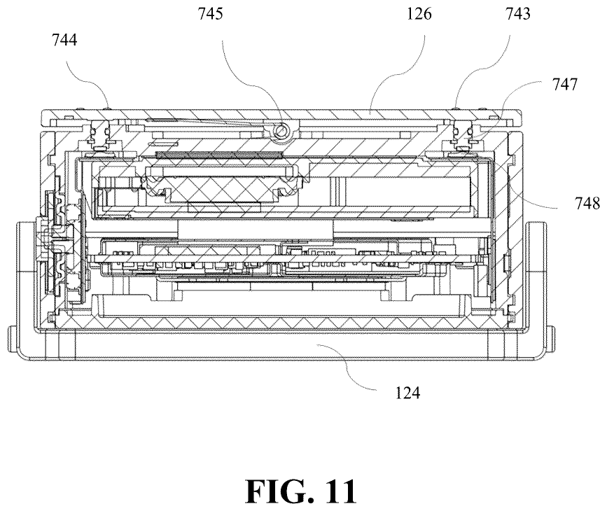

FIG. 7 is an exploded perspective view of an example plate and button assembly of the electronic device according to some implementations. FIG. 11 is a sectional view of the electronic device 100 taken along line A-A of FIG. 1.

As shown in FIGS. 7 and 11, the protruding portion 124 of the second housing portion 120 may include a plate 126. The plate 126 may define a first subregion 702 corresponding to a first button 743 and a second subregion 704 corresponding to a second button 744. For example, a user may press the first button 743 or the second button 744 through the respective subregion 702 or 704 to interact with the electronic device 100. In some implementations, the plate 126 may further include a sound outlet array 706 formed with multiple perforations. The sound outlet array 706 may overlie the apertures 650 of the speaker assembly 600 (FIG. 6), thereby allowing the plate 126 to provide dual functionality as both a sound outlet and an interactive input structure, reducing hardware cost and device thickness. In some implementations, the subregions 702, 704 may occupy most or all of the plate 126 to enlarge the effective operation area of the buttons 743, 744.

The first button 743 and the second button 744 may be implemented in various ways. In some implementations, the protruding portion 124 may further include a fixed shaft 745 connected to the plate 126. The first subregion 702 and the second subregion 704 may be divided by the fixed shaft 745.

The plate 126 may be pivotably mounted about the fixed shaft 745 disposed between the first subregion 702 and the second subregion 704. In some implementations, pivoting the plate 126 toward the first subregion 702 depresses the first button 743 while lifting the plate 126 away from the second button 744. Conversely, pivoting the plate 126 toward the second subregion 704 depresses the second button 744 while lifting away from the first button 743. This rocker-type arrangement allows one button to be actuated while the other is released.

In some implementations, tactile features such as pressing bumps may be provided on the plate 126 to enhance tactile feedback and guide a user to locate the buttons 743, 744. In the example of FIG. 7, an elastic sleeve 746 may be provided on the fixed shaft 745 so that the plate 126 is coupled to the fixed shaft 745 through the elastic sleeve 746.

In some implementations, the electronic device 100 may further include a press detection assembly disposed within the second housing portion 120 and movably connected to the plate 126 for detecting pressing operations on the first button 743 and the second button 744. As shown in FIG. 11, the press detection assembly may include at least two key levers 747, a membrane switch 748, and a sensor (not shown). The key levers 747 are movably disposed within the housing and are aligned with the first subregion 702 and the second subregion 704 of the plate 126 respectively (see FIG. 7).

In the absence of user input, the key levers 747 remain in a free state. The opposite ends of the key levers 747 are disposed adjacent to and spaced from the plate 126 and the membrane switch 748, or alternatively in light contact with the plate 126 and the membrane switch 748 without applying a significant interaction force.

When the user presses the first button 743 or the second button 744, the pressed subregion 702 or 704 moves downward into contact with a corresponding key lever of the key levers 747 and drives the corresponding key lever downward. The downward movement of the key lever 747 brings it into engagement with the membrane switch 748, and the sensor (not shown) may detect the applied force or another parameter at the membrane switch 748 to achieve press detection.

In some implementations, the protruding portion 124 may define respective openings aligned with the subregions 702 and 704, and ends of the key levers 747 may extend through the openings for connection to the plate 126. Opposite ends of the key levers 747 may be pivotally secured within the speaker housing 610. In some examples, at least one limiting groove may be formed on the key lever 747 to engage a limiting post disposed in the speaker housing 610, allowing the key lever 747 to move up and down in the limiting groove while being constrained laterally.

In some implementations, the protruding portion 124 may define openings aligned with the subregions 702, 704, through which ends of the key levers extend. The opposite ends of the key levers may be pivotally mounted inside the speaker housing 610. In some examples, at least one limiting groove may be formed on a key lever, and a corresponding limiting post may extend into the groove to constrain vertical motion of the lever.

In some implementations, the electronic device 100 may further include a microphone assembly 720 disposed on a side surface of the second housing portion 120 to receive voice inputs from a user. The microphone assembly 720 may include one or more microphones arranged on the same side of the electronic device 100, although other arrangements are also possible. In some implementations, the microphone assembly may be implemented as a matrix microphone module to improve pickup directivity and noise suppression.

The microphone assembly 720 may operate in cooperation with the speaker assembly 600 (FIG. 6) to provide voice interaction between the electronic device 100 and the user. Voice inputs received by the microphone assembly 720 may be processed by at least one processor of the electronic device 100 to generate recognition results and corresponding responses. In some implementations, the electronic device 100 may transmit the received voice inputs via a wireless communication module to another device, such as a terminal device or a server, for recognition, and then return a corresponding response. The response may be output to the user through the display 118 or the speaker assembly 600, thereby enabling a natural and interactive voice-based user experience.

FIG. 8 is a rear perspective view of an example of the electronic device 100 in the unfolded configuration, according to some implementations of this disclosure.

As shown in FIG. 8, the second housing portion 120 may include an attachment structure 150 configured to enable releasable mounting of the electronic device 100 to an accessory or support. The attachment structure 150 may include a clamping plate 152 or other engagement member, and may connect to the second housing portion 120 by magnetic attraction, clamping, latching, or other removable connection mechanisms.

In some implementations, the attachment structure 150 may take the form of a support bracket detachably coupled to a rear surface of the second housing portion 120. The support bracket may be configured to receive and retain an accessory, and may define at least one through-hole sized to receive a strap, band, or other mounting element of the accessory.

In some implementations, the attachment structure 150 may be removably disposed on a rear surface of the second housing portion 120, thereby allowing the electronic device 100 to be mounted on objects such as A chest strap or lanyard, a mobile phone, clothing, a helmet, a bicycle, or a handheld pole, to better adapt the device to various use scenarios.

As further shown in FIG. 8, the charging base 160 is disposed at a lower end of the second housing portion 120. The charging base 160 may implemented as a wired connector or as an interface for inductive charging. In the example shown in FIG. 8, the charging base 160 includes a charging port 162. In some implementations, the charging base 160 may also serve as a docking cradle that provides both charging and physical support for the electronic device 100 when not in use. In some implementations, as shown in FIG. 7, the second housing portion 120 may include (at least two) charging sockets 716 and the charging base 160 may include (at least two) charging pins (not shown) arranged to engage the at least two charging sockets 16 for power transmission.

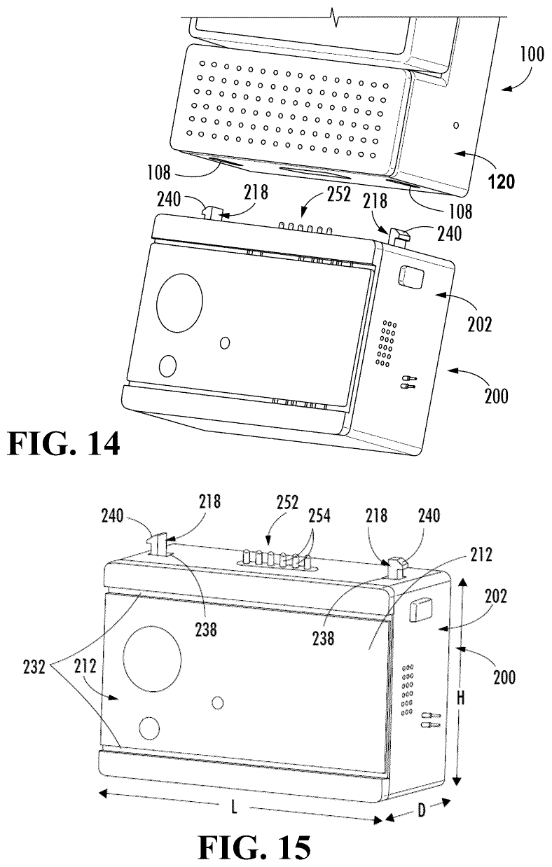

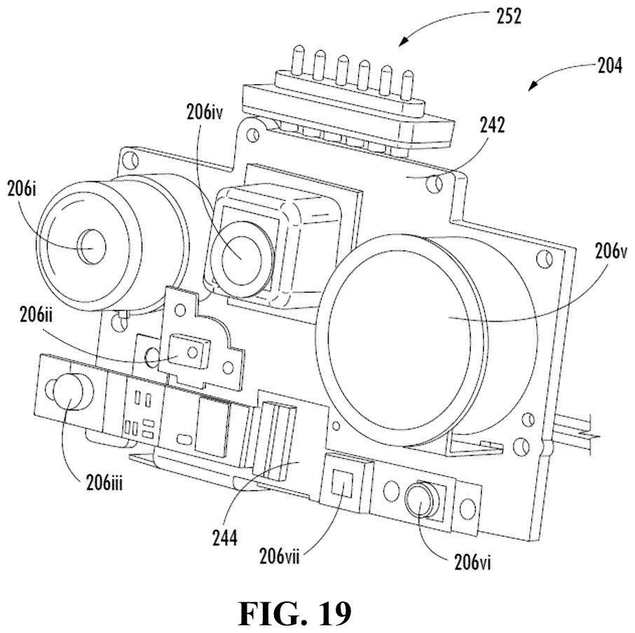

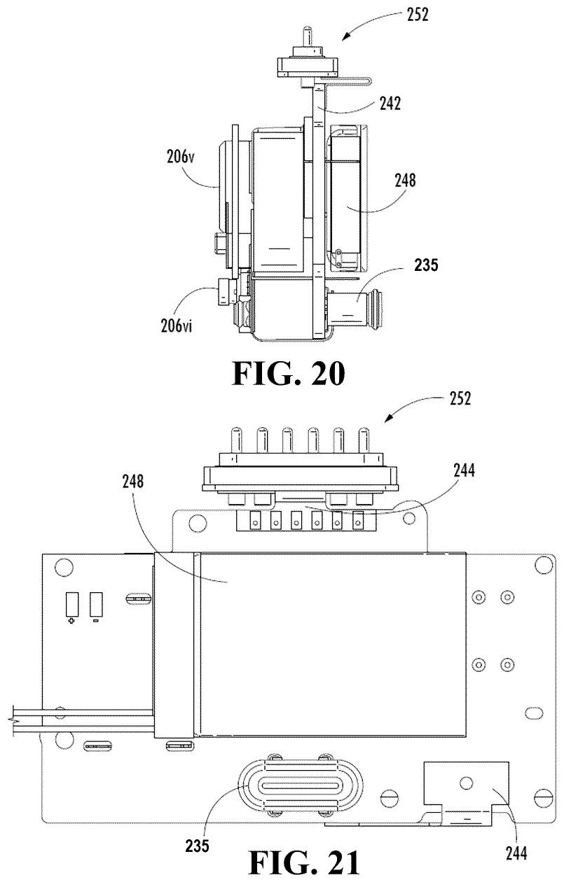

In some implementations, the electronic device 100 is configured for releasable connection to an accessory device (e.g., an accessory device 200 in FIGS. 14-21) that measures various external physiological or environmental parameters in the vicinity of a user and provides the user with health and/or environmental data, e.g., information concerning the user's day-to-day health, sleep quality, etc., based upon the measured parameters in real-time. It is envisioned that the specific configuration and functionality of the electronic device 100 may be varied in alternate embodiments, however.

For example, the accessory device may also include sensors and processing units for detecting, collecting, processing, or displaying one or more physiological or environmental parameters captured by the accessory device or the electronic device 100 in a vicinity of the user. The environmental parameter can include, for example, positioning information, location, altitude, temperature, humidity, environmental light, weather, environmental pollution index such as PM2.5 particulate matter content or CO2/CO content, which can be captured by, for example, one or more environmental sensors of the accessory device or the electronic device 100. The environmental parameter can also include motion data such as motion tracks from a GPS sensor and/or a motion sensor (e.g., one or more of an accelerometer, gyroscope, magnetometer, etc.) or a barometer to record additional measurement data such as altitude. The environmental parameter can include at least one of: altitude, GPS location, ambient temperature, ambient humidity, ambient light, ambient noise index, an environmental pollution index, or other environmental parameter in the vicinity of the user. The accessory sensing device may further include one or more communication modules and I/O units, etc.

In some implementations, the electronic device 100 may utilize environmental data collected by the accessory device or by integrated environment sensors within the electronic device 100 to dynamically control device functions. For example, sensor input may be used to adjust camera parameters or the orientation of the housing portions 110, 120, such as activating a UV filter or adjusting image color balance when ultraviolet intensity exceeds a threshold, or re-orienting the at least one camera 114 toward an object of interest identified from the sensor data. In another example, detection of ambient brightness below a threshold may cause at least a portion of the LED strip module 116 or a flash element to illuminate, while detection of excessive particulate matter (e.g., PM2.5) or unsuitable ambient conditions may prompt the electronic device 100 to fold. Environmental data may further be logged alongside captured images or video frames to form a video log annotated with contextual information, or transmitted together with image data to a mobile terminal or server for further processing. The electronic device 100 may also generate user alerts based on environmental data, such as warnings in response to abnormal temperature, humidity, or gas concentration, and may adapt the alert modality (e.g., visual output on the display 118, audio output via the speaker assembly 600, or haptic output) according to surrounding conditions. In some implementations, environmental and motion data may be used for sleep quality analysis and to provide tailored recommendations, and may also be combined with health data or exchanged with external wearable devices to support broader fitness and wellness applications.

With reference to FIGS. 14-21, the accessory device 200 will be discussed in further details. The accessory device 200 is releasably and physically connectable with the electronic device 100, which allows the accessory device 200 to be repeatedly connected to and disconnected therefrom. The accessory device 200 collects, processes, and transmits the aforementioned sensor data to the electronic device 100. The accessory device 200 includes: a housing assembly 202; an electronics assembly 204 (referred to as a second electronics assembly); and a plurality of sensors 206, e.g., a plurality of environmental sensors.

The accessory device 200 is a lightweight and portable (e.g., wearable) unit with a total weight that is less than 50g and reduced dimensions (e.g., compared to known sensor devices). More specifically, in the illustrated embodiment, the accessory device 200 includes a total weight that lies substantially within the range of approximately 20 g to approximately 50 g (e.g., approximately 30 g) and defines a total length L that lies substantially with the range of approximately 45 mm to approximately 50 mm, a total depth D that lies substantially with the range of approximately 20 mm to approximately 25 mm, and a total height H that lies substantially with the range of approximately 30 mm to approximately 35 mm. Alternatively, one or more of the above-mentioned dimensions of the accessory device 200 may be other values, which are not enumerated herein.

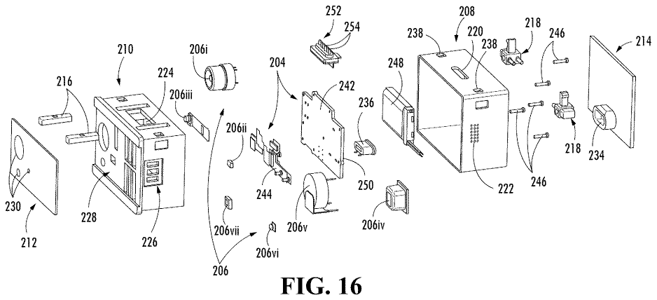

The housing assembly 202 is the main structural component of the accessory device 200 and accommodates and supports the various internal components thereof including, for example, the electronics assembly 204 and the sensors 206. In the implementation shown in FIG. 16, the housing assembly 202 includes: an outer housing 208; an inner housing 210, which is positioned within the outer housing 208; a front cover 221; a rear cover 214; at least one magnetic member 216 (referred to as a second magnetic member); and one or more engagement members 218 (e.g., clips, buckles).

The outer housing 208 conceals and protects the inner housing 210 as well as the various internal components of the accessory device 200. In the example shown in FIG. 16, the outer housing 208 is configured as a sleeve 220 that receives the inner housing 210 and includes at least one ventilation opening 222 (referred to as a first ventilation opening), which allows for the inflow of air or gas (e.g., carbon dioxide, carbon monoxide, etc.) into the accessory device 200 in order to facilitate detection, as described in further detail below.

The inner housing 210 defines an inner compartment 224, which receives the various internal components of the accessory device 200 (e.g., the electronics assembly 204 and the sensors 206), and includes one or more ventilation openings 226 (referred to as second ventilation openings), which are generally aligned with the ventilation openings 222 in the outer housing 208, and one or more vents 228, each of which allows for the inflow of gas (e.g., carbon dioxide, carbon monoxide, etc.) into the accessory device 200 in order to facilitate detection, as described in further detail below.

The front cover 212 is connected (or secured) to the inner housing 210 and defines one or more openings 230 that are generally aligned with one or more of the sensors 206 in order to allow for communication with the ambient during collection of the sensor data. In the implementation shown in FIG. 15, the front cover 212 is connected (or secured) to the inner housing 210 so as to define at least one groove (or channel) 232, which extends about the front cover 212. The at least one groove 232 not only allows for the inflow of gas (e.g., carbon dioxide, carbon monoxide, etc.) into the accessory device 200 in order to facilitate detection, as described in further detail below, but improve integration and the overall aesthetic appearance of the accessory device 200.

The rear cover 214 is connected (or secured) to the inner housing 210 and defines an opening 234. The opening 234 is generally aligned with a charging structure (or port) 235, which is discussed in further detail below.

In one embodiment of the disclosure, it is envisioned that the front and rear covers 212, 214 may be fixedly (e.g., non-removably) connected to at least one of the outer housing 208 and the inner housing 210. Alternatively, it is envisioned that the respective front and rear covers 212, 214 may be removable from the accessory device 200 in order to facilitate access to the various internal components thereof (e.g., the electronics assembly 204, the sensors 206, etc.) during repair, maintenance, replacement, etc.

The at least one magnetic member 216 is connected (or secured) to the inner housing 210 and corresponds in location to at least one magnetic member included in the electronic device 100. The at least one magnetic member 216 facilitates magnetic connection of the electronic device 100 and the accessory device 200 in order to increase stability of the connection between the electronic device 100 and the accessory device 200 and/or inhibit (if not entirely prevent) unintended relative movement therebetween (e.g., rattle).

In the illustrated embodiment, the accessory device 200 includes a pair of the magnetic members 216 (e.g., such that the magnetic members 216 in the accessory device 200 correspond in number to the magnetic members in the electronic device 100). It is envisioned, however, that the specific number of magnetic members 216 may be varied in alternate embodiments (e.g., depending upon the particular configuration(s) thereof, the particular number and/or configuration(s) of the magnetic member(s) in the electronic device 100, the particular configuration of the accessory device 200, the functionality and/or the intended use thereof, the number of sensors 206 included in the accessory device 200, etc.). For example, embodiments in which the electronic device 100 and the accessory device 200 may include different numbers of magnetic members 216 are also envisioned herein as are embodiments in which the electronic device 100 and/or the accessory device 200 may respectively include a single magnetic member 216.

The one or more engagement members 218 are connected (or secured) to the inner housing 210 and extend through one or more openings 238 in the outer housing 208. The engagement members 218 are configured for removable insertion into openings 108 (FIG. 14) defined by the second housing portion 120 of the electronic device 100 in order to facilitate connection of the electronic device 100 and the accessory device 200. The accessory device 200 is thus physically connectable with the electronic device 100 via the interface between the magnetic members 216 and the interface between the engagement members 218 and the second housing portion 120.

The engagement members 218 include (or define) one or more angled (or chamfered, beveled) bearing surfaces 240 (FIGS. 14, 15), which are configured for engagement (or contact) with the second housing portion 120 of the host device 100 during connection with the accessory device 200. Upon insertion of the engagement members 218 into the openings 108 and advancement of the accessory device 200 towards the electronic device 100, the bearing surfaces 240 engage (or contact) the second housing portion 120 of the electronic device 100, which repositions the engagement members 218 from a normal (e.g., initial) position into a deflected (e.g., subsequent) position.

In certain embodiments, it is envisioned that the engagement members 218 may be resiliently repositionable between the normal and deflected positions and biased towards the normal position via one or more biasing members (e.g., springs) such that the engagement members 218 automatically return to the normal position upon insertion into the openings 108 and separation of the electronic device 100 and the accessory device 200. Embodiments in which the engagement members 218 may be configured for manual repositioning between the normal and deflected positions are also envisioned herein, however. Although shown as including both the magnetic members 216 and the engagement members 218, embodiments in which the magnetic members 216 or the engagement members 218 may be omitted are also envisioned herein. As such, it is envisioned that the electronic device 100 and the accessory device 200 may be configured for mechanical and/or magnetic connection.

The electronics assembly 204 is supported by (e.g., is connected or secured to) the housing assembly 202 (e.g., within the inner compartment 224), and includes a main board 242 and an FPC 244.

The main board 242 is connected (or secured) to the housing assembly 202. More specifically, the main board 242 is directly and mechanically connected (or secured) to the inner housing 210 via one or more fasteners 246, which extend through the main board 242 and into the inner housing 210.

The main board 242 includes the aforementioned charging port 235, which allows the accessory device 200 to be connected to an external power source during charging, and a battery 248, each of which is connected (or secured) to a rear face 250 of the main board 242.

The FPC 244 is physically and electrically connected to the main board 242, which allows for data transmission therebetween. The FPC 244 includes an electrical contact structure 252 (referred to as a second electrical contact structure), e.g., one or more conductive pins 254, which are thus indirectly connected to the main board 242 via the FPC 244. The electrical contact structure 252 is configured for engagement (or contact) with an electrical contact structure (not shown) on an electronics assembly (not shown) in the electronic device 100, whereby the electronics assembly directly engages (or contacts) the electronic device 100. Engagement (or contact) between the electrical contact structures establishes an electrical connection between the electronic device 100 and the accessory device 200 that facilitates the communication of data (e.g., the sensor data) and/or power therebetween. For example, it is envisioned that the electronic device 100 may supply power to the accessory device 200 to charge the accessory device 200 when the accessory device 200 is not connected to the aforementioned external power source or when power of the accessory device 200 is below a certain threshold.

The electronics assembly 204 supports operation and various functional aspects of the accessory device 200 including, for example, collection, processing, and transmission of the sensor data, communication with the electronic device 100 and/or an external network, power regulation, temperature control of the accessory device 200, etc. In order to support such operation and functionality, it is envisioned that the main board 242 and/or the FPC 244 may include or otherwise support one or more processors, memory modules, heat sinks, or other such components, which may be omitted from the drawings in the interest of clarity.

The sensors 206 include environmental sensors that are configured to measure various environmental parameters in the vicinity of the user (e.g., parameters that are external to the user), as opposed to physiological parameters that are internal and specific to the user (e.g., heart rate, heart rate variability, blood pressure, blood glucose level, respiration rate, body temperature, mental state, stress state, etc.) in order to collect and provide the sensor data to the user in real-time.

In the illustrated embodiment, the sensors 206 include: an infrared sensor 206i; a light sensor 206ii, which is configured to detect one or more bands of ambient light (e.g., ultraviolet light); an air quality sensor 206iii; a carbon dioxide sensor 206iv, which is positioned (located) in generally alignment with a vent 228i (referred to as a first vent) in the inner housing 210 in order to allow for the inflow of carbon dioxide into the accessory device 200; a carbon monoxide sensor 206v, which is positioned (located) in generally alignment with a vent 228ii (referred to as a second vent) in the inner housing 210 in order to allow for the inflow of carbon monoxide into the accessory device 200; a barometer 206vi, which is positioned (located) in generally alignment with a vent 228iii (referred to as a third vent) in the inner housing 210 in order to allow for pressure and/or altitude measurement; and an integrated temperature and humidity sensor 206vii, which is positioned (located) in generally alignment with a vent 228iv (referred to as a fourth vent) in the inner housing 210 in order to allow ambient air to enter the accessory device 200. Depending on the particular functionality and/or the intended use of the accessory device 200, however, it is envisioned that the accessory device 200 may include any three (or more) of the sensors 206 in various combinations.

The sensors 206 are supported by (e.g., are directly connected or secured to) the electronics assembly 204, which increases integration and reduces the overall size of the accessory device 200 in order to facilitate and improve portability. More specifically, as seen in FIG. 17, the infrared sensor 206i, the carbon dioxide sensor 206iv, and the carbon monoxide sensor 206v are provided on, e.g., directly connected to, the main board 242, and the light sensor 206ii, the air quality sensor 206iii, the barometer 206vi, and the temperature and humidity sensor 206vii are provided on, e.g., directly connected to, the FPC 244. The light sensor 206ii, the air quality sensor 206iii, the barometer 206vi, and the temperature and humidity sensor 206vii are, thus, indirectly connected to the main board 242 via the FPC 244.

In the illustrated embodiment, the infrared sensor 206i, the light sensor 206ii, and the air quality sensor 206iii are positioned (located) on a left side of the accessory device 200 (when viewed from the front), and the carbon dioxide sensor 206iv, the carbon monoxide sensor 206v, the barometer 206vi, and the temperature and humidity sensor 206vii are positioned (located) on a right side of the accessory device 200. It is envisioned, however, that the specific positions (locations) of the sensors 206 may be varied (in alternate embodiments (e.g., depending upon the particular number of sensors 206 included in the accessory device 200, the particular configuration (e.g., the size and/or the shape) of the accessory device 200, the functionality and/or the intended use thereof, etc.).

The infrared sensor 206i facilities the precise measurement of ambient temperature with a high degree of thermal stability, even under rapidly changing temperature conditions. In some implementations, the infrared sensor 206i may be configured to measure ambient temperature substantially within the range of approximately −40° C. to approximately 300° C. with an error that lies substantially within the range of approximately 1° C. to approximately 2° C.

The air quality sensor 206iii detects particulate in the air (e.g., PM2.5) in order to measure pollution. In some implementations, the air quality sensor 206iii may utilize light (e.g., a laser emission), which is focused by one or more lenses at a distance that lies substantially within the range of approximately 3 mm to approximately 7 mm, in order to detect particulate propagating in free space. The air quality sensor 206iii detects light that is scattered via interaction with the particulate via an integrated photodetector, and the particulate matter concentration is then derived via an algorithm.

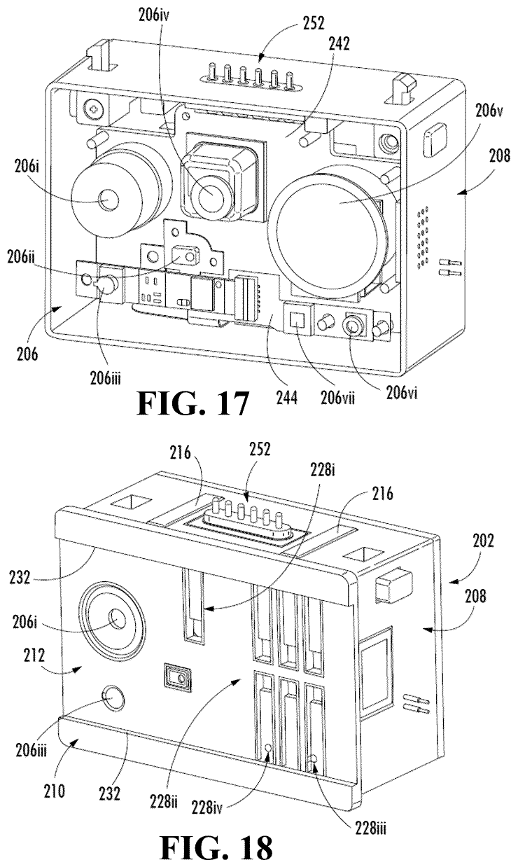

The carbon dioxide sensor 206iv detects (measures) the presence of carbon dioxide in the ambient, which may enter the accessory device 200 through the at least one groove 232 (FIGS. 15, 18). During detection, light pulses from an infrared light source pass through a filter that is tuned to a wavelength of approximately 4.2 μm. The carbon dioxide molecules in the detection area absorb the filtered light, which excites the molecules, causing them to generate pressure waves. The pressure waves are detected by an acoustic (MEMS) detector, which generates an output signal that is communicated to a microcontroller included in the carbon dioxide sensor 206iv in order to generate a carbon dioxide concentration reading. In order to increase the accuracy of the carbon dioxide concentration reading, it is envisioned that the acoustic detector may be optimized for low-frequency operation and that the detection area may be acoustically isolated from external noise.

The carbon monoxide sensor 206v detects (measures) the presence of carbon monoxide, which may enter the accessory device 200 through the at least one groove 232 (FIGS. 15, 18), by measuring the current flowing through the carbon monoxide sensor 206v. During detection, carbon monoxide passes through a diffusion membrane to a working electrode, thereby forming protons and electrons as part of a carbon monoxide oxidation reaction. By connecting the working electrode to a counter electrode, a short circuit is created, whereby the protons and the electrons on the working electrode migrate to the counter electrode. The protons then react with oxygen on the counter electrode, which creates measurable current in the carbon monoxide sensor 206v.

In the illustrated embodiment, at least one of the electronic device 100 or the accessory device 200 is configured to interact with the user upon determining that certain conditions have been met (e.g., upon determining that a threshold metric has been exceeded). For example, it is envisioned that the electronic device 100 and/or the accessory device 200 may be configured to remind the user (or suggest to the user) to dim the lighting and/or to close a window upon detecting that a certain temperature and/or humidity has been reached. Additionally, or alternatively, the electronic device 100 and/or the accessory device 200 may be configured to alert the user to elevated levels of carbon dioxide and/or carbon monoxide.

It is also envisioned that at least one of the electronic device 100 or the accessory device 200 may be configured to assess the user's safety and/or comfort. For example, it is envisioned that the accessory device may be configured to at least one of: determine whether a measured temperature exceeds a threshold or to detect events or circumstances that are counter (e.g., not conducive) to the user's health such as, for example, the presence of carbon dioxide and/or carbon monoxide in concentrations that exceed a threshold.

It is also envisioned that at least one of the electronic device 100 or the accessory device 200 (e.g., the sensors 206) may be configured to provide the user with a sleep analysis and/or monitor the user's sleep (e.g., by alerting the user to the occurrence of snoring, variation in the user's sleep pattern, etc.) based upon measurement of the external parameters by the sensors 206 and the sensor data. For example, it is envisioned that at least one of the electronic device 100 or the accessory device 200 may be configured to measure various sleep environment parameters in order to determine the impact of the environment on sleep quality.

In one particular implementation, it is envisioned that at least one of the electronic device 100 or the accessory device 200 may be configured to determine the environmental impact on the user's sleep and provide the user with suggestions, reminders, alerts, or the like. For example, it is envisioned that the electronic device 100 and/or the accessory device 200 may be configured to provide suggestions relating to one or more of: temperature conditions (e.g., based on measurement(s) taken by the infrared sensor 206i); lighting conditions (e.g., based on measurement(s) taken by the light sensor 206ii); air quality conditions (e.g., based on measurement(s) taken by the air quality sensor 206iii); carbon and/or carbon dioxide concentrations (e.g., based on measurement(s) taken by the carbon dioxide sensor 206iv and/or the carbon monoxide sensor 206v); pressure (e.g., based on measurement(s) taken by the barometer 206vi); or temperature and/or humidity (e.g., based on measurement(s) taken by the temperature and humidity sensor 206vii).

In certain implementations, it is envisioned that another electronic device, such as a client device or a server, may determine the environmental impact on the user's sleep. The user's sleep data may be obtained, such as by a wearable device, and the environmental data detected by accessory device 200 associated with the sleep data may be obtained. The user's sleep quality may be determined based on the user's sleep data, and the impact of the environment on the user's sleep may be determined based on the user's sleep quality and/or the combination of the user's sleep data and the environmental data. For example, during such a determination, it is envisioned that one or more of the following may be considered: environmental parameters that have an impact on, improve, or reduce the user's sleep quality, the correlation between specific environmental parameters and the user's sleep quality, one or more environmental arrangements that require improvement, etc.

In certain implementations, the electronic device 100 and the accessory device 200 may be equipped with adapted charging structures such that, upon connection of the electronic device 100 and the accessory device 200, one can power or charge the other.

In certain implementations of data and/or command interaction between the electronic device 100 and the accessory device 200, the accessory device 200 may include a memory that stores detected sensor data when not connected to the electronic device 100 and transmits the stored sensor data to the electronic device 100 once a connection between the electronic device 100 and the accessory device 200 is established. Alternatively, it is envisioned that the accessory device 200 may be devoid such memory and may instead directly transmit the detected sensor data to the electronic device 100.

In certain implementations, it is envisioned that the accessory device 200 may activate one or more of the sensors 206 by default after startup. Alternatively, it is envisioned that the accessory device 200 may activate one or more of the sensors 206 after being connected to the electronic device 100 or that the accessory device 200 may activate one or more of the sensors 206 after receiving instructions from the electronic device 100.

In certain implementations, it is envisioned that select sensors 206 may be activated while the remaining sensors 206 remain deactivated. For example, it is envisioned that certain of the sensors 206 may be activated by default while certain of the sensors 206 may only be activated upon meeting particular conditions.

In certain implementations, it is envisioned that the accessory device 200 may include a data transmission interface and transmit data to the electronic device 100 through a wired connection.

In certain implementations, it is envisioned that the sensor data may be used to generate annotations for image data collected by the electronic device 100 and/or that the sensor data may be used in conjunction with the image data to generate a personal life log for the user.

In certain implementations, it is envisioned that the sensor data may be used to adjust the configuration of the electronic device 100. For example, it is envisioned that the sensor data may be used to adjust a folding angle of the electronic device 100 and/or image capture parameters (or settings) of the at least one camera 114.

In certain implementations, it is envisioned that the sensor data may be used to provide motion data, which, together with food image data collected by the at least one camera 114, may be processed or compiled into health data for the user.

In certain implementations, it is envisioned that dietary recommendations and/or exercise recommendations may be provided to the user based upon the health data for the user.

In certain implementations, it is envisioned that the accessory device 200 may include a microprocessor for preprocessing the detected sensor data and transmitting the preprocessed data to the electronic device 100, where the data volume of the preprocessed data is lower than the original sensor data. In such implementations, it is also envisioned that the microprocessor may be used to preliminarily determine the occurrence of a specific event based on the detected sensor data, and send relevant data to the electronic device 100 in response to detecting the specific event, so that the electronic device 100 can perform secondary confirmation based on the relevant data and issue a reminder to the user.

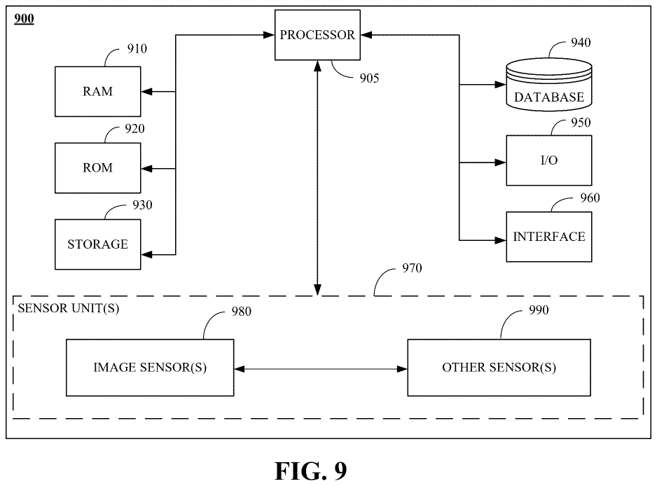

In some implementations, the electronic device 100 may also include a non-transitory memory and at least one processor, which can include, for example, a microcontroller, a microprocessor, a programmable logic circuit, a special integrated circuit, a control circuit, or software instructions that can be implemented in any of the above to control the rotation angle of at least one of the housing portions 110, 120, and automatically rotate at least one of the housing portions 110, 120 based on information collected from the at least one camera 114. The instructions described here can be based on software, hardware or firmware. FIG. 9 is a block diagram of an example of a computing device 900 that may be used with or incorporated into the electronic device 100, according to some implementations of this disclosure.

The computing device 900 is representative of the type of computing device that may be present in or used in conjunction with at least some aspects of the device 100, or any other device comprising electronic circuitry. For example, the computing device 900 may be integrated with or within the electronic device 100 (e.g., within the first housing portion 110 or the second housing portion 120), or may be a separate mobile terminal or remote device in communication with the electronic device 100. The computing device 900, the electronic device 100 (if separate), or both may be in communication with a server (e.g., a cloud-based server). Alternatively, the computing device 900 may be in direct communication with the server and the device 100 may be in communication with the server via the computing device 900. It should also be noted that the computing device 900 is illustrative only and does not exclude the possibility of another process-or controller-based system being used in or with any of the aforementioned aspects of the electronic device 100. For example, the computing device 900 may be used in conjunction with any one or more of transmitting signals to and from the one or more optical sensors or acoustical sensors, sensing or detecting signals received by one or more sensors of the electronic device 100, processing received signals from one or more components or modules of the electronic device 100 or a secondary device, and storing, transmitting, or displaying information.

The computing device 900 may include one or more hardware and/or software components configured to execute software programs, such as software for obtaining, storing, processing, and analyzing signals, data, or both. For example, the computing device 900 may include one or more hardware components such as a processor 905, a random-access memory (RAM) 910, a read-only memory (ROM) 920, a storage 930, a database 940, one or more input/output (I/O) modules 950, an interface 960, and one or more sensors 970. The RAM 910, the ROM 920, the storage 930 or other memory device may be implemented as a non-transitory computer-readable medium configured to store instructions and data.

Alternatively, and/or additionally, the computing device 900 may include one or more software components such as a computer-readable medium including instructions executable by the processor 905 to perform functions consistent with the present disclosure. It is contemplated that one or more of the hardware components listed above may be implemented using software. For example, the storage 930 may include a software partition associated with one or more other hardware components of the computing device 900. The computing device 900 may include additional, fewer, and/or different components than those listed above.

The processor 905 may include one or more processors, each configured to execute instructions and process data to perform one or more functions associated with the computing device 900. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 9, the processor 905 may be communicatively coupled to the RAM 910, the ROM 920, the storage 930, the database 940, the I/O module 950, the interface 960, and the one or more sensors 970. The processor 905 may be configured to execute sequences of computer program instructions to perform various processes, which will be described in detail below. The computer program instructions may be loaded into the RAM 910 for execution by the processor 905.

The RAM 910 and the ROM 920 may each include one or more devices for storing information associated with an operation of the computing device 900 and/or the processor 905. For example, the ROM 920, may include a memory device configured to access and store information associated with the computing device 900, including information for identifying, initializing, and monitoring the operation of one or more components and subsystems of the computing device 900. The RAM 910 may include a memory device for storing data associated with one or more operations of the processor 905. For example, instructions stored in the ROM 920 may be loaded into the RAM 910 for execution by the processor 905.

The storage 930 may include any type of storage device configured to store information that the processor 905 may use to perform processes consistent with the disclosed embodiments.

The database 940 may include one or more software and/or hardware components that cooperate to store, organize, filter, and/or arrange data used by the computing device 900 and/or the processor 905. For example, the database 940 may include user profile information, historical activity and user-specific information, physiological parameter information, predetermined menu/display options, and other user preferences. Alternatively, the database 940 may store additional and/or different information. For example, the database 940 may include information to establish a machine learning model such as a language model (e.g., an LLM) that can receive inputs from the I/O module 950 or sensor(s) 970.

The I/O module 950 may include one or more components configured to communicate information with a user associated with the computing device 900. For example, the I/O module 950 may include one or more buttons, switches, or touchscreens to allow a user to input parameters associated with the computing device 900. The I/O module 950 may also include a display including a graphical user interface (GUI) and/or one or more light sources for outputting information to the user. The I/O module 950 may also include one or more communication channels for connecting the computing device 900 to one or more secondary or peripheral devices such as, for example, a desktop computer, a laptop, a tablet, a smart phone, a flash drive, or a printer, to allow a user to input data to or output data from the computing device 900.

The interface 960 may include one or more components configured to transmit and receive data via a communication network, such as the internet, a local area network, a workstation peer-to-peer network, a direct link network, a wireless network, or any other suitable communication channel. For example, the interface 960 may include one or more modulators, demodulators, multiplexers, demultiplexers, network communication devices, wireless devices, antennas, modems, and any other type of device configured to enable data communication via a communication network.

The computing device 900 may further include the one or more sensors 970. The one or more sensors 970 may include, for example, an image sensor 980 (e.g., the at least one camera 114 described above) and/or other sensors 990 such as an accelerometer, an optical sensor, an acoustical sensor, an ambient light sensor, a pressure sensor, a contact sensor, an electromagnet sensor, an ECG electrode, and/or a bio impedance sensor. These examples are illustrative only, and the sensors 970 may include alternative or additional sensors suitable for use in the electronic device 100.

It should also be noted that although one or more sensors 970 are described collectively, any sensor or sensor unit within the computing device 900 may operate independently of other sensors. Moreover, in addition to collecting, transmitting, and receiving signals or information to and from the one or more sensors 970 at the processor 905, any of the one or more sensor units of the one or more sensors 970 may be configured to collect, transmit, or receive signals or information to and from other components or modules of the computing device 900, including but not limited to the database 940, the I/O module 950, or the interface 960.

The accelerometer may be used to detect large-scale motions of a subject indicative of physical activity (e.g., steps, running, walking, swimming, etc.). The same accelerometer may be used to determine the onset of a sleep period through the detection of a lack of motion. The acoustical sensor may be used to detect and monitor heart rate. In some implementations, the sensitivity of the acoustical sensor may be adjusted to detect relatively slow heart rates during sleep, or dedicated acoustical sensors may be provided for sleep monitoring while others monitor heart rate during activity.

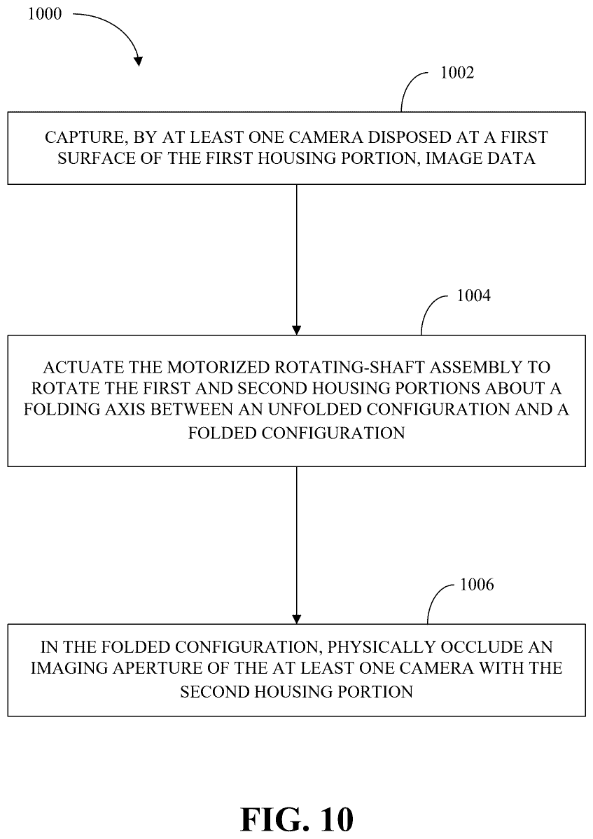

FIG. 10 is a flow diagram of an example method 1000 of operating the electronic device 100, according to some implementations of this disclosure. It should be noted that the flow diagram and the method 1000 may be used interchangeably herein. The method 1000 may be implemented as software and/or hardware modules of the electronic device 100 (e.g., within the computing device 900 of FIG. 9). For example, the method 1000 may be implemented as software instructions stored in the storage 930 of the computing device 900 and executed by the processor 905. Some or all of the operations of the method 1000 may also be implemented by specialized hardware such as an ASIC or FPGA configured to perform functions such as controlling actuation of the motorized rotating-shaft assembly 400 (i.e., the drive assembly 400). In some implementations, the method 1000 may be distributed across multiple devices, such as the electronic device 100 and a secondary computing device (e.g., a mobile terminal or server in communication with the electronic device 100).

In some implementations, when the at least one camera 114 is activated, it may be configured to capture still pictures and/or video streams. A corresponding measurement may be obtained in response to activation of the at least one camera 114. In some examples, the captured image data may be processed locally by the electronic device 100 or transmitted to a companion device or server for further analysis.

In some implementations, the electronic device 100 may also capture supplemental sensor data in addition to the image data. The supplemental data may include physiological parameters such as heart rate, heart rate variability (HRV), blood pressure, blood glucose level, respiration rate, body temperature, or other physiological information of the user. The supplemental data may further include environmental parameters such as altitude, GPS location, ambient temperature, ambient humidity, ambient noise index, an environmental pollution index, or other environmental information sensed in the vicinity of the user. The combination of image data with physiological and/or environmental data enables multimodal sensing tasks and supports more comprehensive applications such as health monitoring, fitness tracking, and context-aware device control.

At an operation 1002, image data is captured by the at least one camera 114 disposed on the first surface 112 of the first housing portion 110. In some implementations, the first surface 112 is free of a display, thereby reserving the surface for imaging functionality without interference from a display element. The image data may include still images or video data, and may be supplemented by additional sensor data from the electronic device 100 or from another device (e.g., an accessory device) for multimodal sensing tasks such as activity recognition, environmental monitoring, or context-aware control.

In some implementations, image stabilization parameters of the at least one camera 114 may be adjusted based on signals from the one or more sensors 970 (e.g., gyroscope) during image capture, thereby compensating for motion of the electronic device 100 and enhancing the quality of captured images.

In some implementations, at least one object may be detected by the processor 905 of the electronic device 100 based on image data captured by the at least one camera 114 and/or supplemental data obtained from additional sensor(s). For example, objects that may be detected include a person or an animal appearing in the captured scene, or food items being consumed by the user. In some implementations, additional tasks associated with the detected object may be performed, such as capturing a high-resolution image of each food item for analysis and/or uploading the captured image data to a remote server for further processing.

In some implementations, a parameter derived from data collected by the additional sensor(s) may be used to determine a type or classification of the detected object. For example, the type of a beverage (e.g., alcoholic versus non-alcoholic) may be determined based on a measurement obtained by a volatile organic compound (VOC) sensor included in the electronic device 100 or the accessory device.

In some implementations, image information collected by the at least one camera 114 and/or angle information from the angle detection module may be used to determine a rotation angle or a target rotation angle between the first housing portion 110 and the second housing portion 120. The target rotation angle may be based on image recognition results of the captured scene, such as identifying a target object, determining whether an object is complete in the frame, or adjusting to optimize a shooting scene. The target rotation angle may also be determined by user instruction or by a detected environmental condition.

At an operation 1004, the motorized rotating-shaft assembly 400 disposed within the connector 130 of the electronic device 100 may be actuated to rotate the first housing portion 110 and the second housing portion 120 about the folding axis X between an unfolded configuration and a folded configuration, as described above with reference to FIGS. 1-5.

In some implementations, a desired angle may be selected from a set of discrete desired angles, and the motorized rotating-shaft assembly 400 is driven to position the first and second housing portions 110, 120 at the desired angle.

In some implementations, upon detecting the object of interest, at least one electric motor 402 of the motorized rotating-shaft assembly 400 may be actuated to rotate the first and second housing portions 110, 120 so as to reorient an optical axis of the at least one camera 114 toward the object.

In some implementations, the image information from the at least one camera 114 may be uploaded through a communication network to a terminal device or server for further processing, such as image recognition or dietary intake analysis. For example, upon detecting a dietary item (e.g., food or drink), the processor 905 may analyze the dietary item to determine a type and associated intake data, including calories and nutritional content. The intake data may be combined with user activity data to provide dietary and health recommendations. For instance, the intake data can be compared against target values to determine whether the user's consumption exceeds a reference or expected value, and if so, an activity recommendation can be provided to offset excess intake. In some implementations, the intake data may be transmitted to a server that generates a summary or recommendations for the user, such as nutritional references, dietary suggestions, exercise suggestions, or exercise plans over a given period of time.

At an operation 1006, in the folded configuration, an imaging aperture of the at least one camera 114 in the first housing portion 110 is physically occluded with the second housing portion 120, thereby concealing the at least one camera 114 from external exposure, as described above with reference to FIG. 2.

In some implementations, image capture by the at least one camera 114 may be disabled in response to determining that the imaging aperture of the at least one camera 114 is physically occluded in the folded configuration, thereby reducing power consumption and preventing unintended image capture when the electronic device 100 is folded.

A person skilled in the art will note that all or a portion of the aspects of the disclosure described herein can be implemented using a general-purpose computer/processor with a computer program that, when executed, carries out any of the respective techniques, algorithms, and/or instructions described herein. In addition, or alternatively, for example, a special-purpose computer/processor, which can contain specialized hardware for carrying out any of the techniques, algorithms, or instructions described herein, can be utilized.

Similarly, all or a portion of the aspects of the disclosure described herein can be implemented by the device 100 (e.g., by the processor 905 when the computing device 900 is incorporated into the device 100), by a server in communication with the device 100 and/or the computing device 900, or both. Additionally, all or a portion of the aspects of the disclosure described herein (e.g., steps, procedures, processes, etc.) may be performed by the device 100, or the computing device 900, or a secondary companion device (e.g., a mobile terminal, a client device, other remote device, another wearable device etc.). For example, a portion of the steps or procedures described herein may be performed by the aforementioned server while another portion of the steps or procedures may be performed by the secondary companion device.

Technical specialists skilled in the art should understand that the implementations in this disclosure may be implemented as methods, systems, or computer program products. Therefore, this disclosure may be implemented in forms of a complete hardware implementation, a complete software implementation, and a combination of software and hardware implementation. Further, this disclosure may be embodied as a form of one or more computer program products which are embodied as computer executable program codes in computer writable storage media (including but not limited to disk storage and optical storage).

This disclosure is described in accordance with the methods, devices (systems), and flowcharts and/or block diagrams of computer program products of the implementations, which should be comprehended as each flow and/or block of the flowcharts and/or block diagrams implemented by computer program instructions, and the combinations of flows and/or blocks in the flowcharts and/or block diagrams. The computer program instructions therein may be provided to generic computers, special-purpose computers, embedded computers or other processors of programmable data processing devices to produce a machine, wherein the instructions executed by the computers or the other processors of programmable data processing devices produce an apparatus for implementing the functions designated by one or more flows in the flowcharts and/or one or more blocks in the block diagrams.

The computer program instructions may be also stored in a computer readable storage which is able to boot a computer or other programmable data processing device to a specific work mode, wherein the instructions stored in the computer readable storage produce a manufactured product containing the instruction devices which implements the functions designated by one or more flows in the flowcharts and/or one or more blocks in the block diagrams.

The computer program instructions may also be loaded to a computer or another programmable data processing device to execute a series of operating procedures in the computer or the other programmable data processing device to produce a process implemented by the computer, whereby the computer program instructions executed in the computer or the other programmable data processing device provide the operating procedures for the functions designated by one or more flows in the flowcharts and/or one or more blocks in the block diagrams.

Apparently, the technical specialists skilled in the art may perform any variation and/or modification to this disclosure by the principles and within the scope of this disclosure. Therefore, if the variations and modifications herein are within the scope of the claims and other equivalent techniques herein, this disclosure intends to include the variations and modifications thereof.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising”, and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. The terms “at least one of A or B,” “at least one of A and B,” “one or more of A or B,” “A and/or B” used herein mean “A”, or “B” or “A and B”.

While the disclosure has been described in connection with certain embodiments or implementations, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An electronic device, comprising:
a housing reconfigurable between an unfolded configuration and a folded configuration about a folding axis, comprising:
a first housing portion having a first surface and at least one camera disposed at the first surface, wherein the first surface is free of a display;
a second housing portion hingeably coupled to the first housing portion about the folding axis; and
a connector disposed between the first and second housing portions, the connector comprising a motorized rotating-shaft assembly configured to effect coordinated rotation of the first and second housing portions about the folding axis between the unfolded configuration and the folded configuration,
wherein, in the folded configuration, the second housing portion overlies at least part of the first surface to physically occlude the at least one camera.

2. The electronic device of claim 1, wherein the second housing portion comprises:
a flat portion coupled to the connector; and
a protruding portion comprising a speaker housing, wherein a speaker unit is disposed in the speaker housing, and
wherein, in the folded configuration, the flat portion faces the first housing portion, and the flat portion is disposed over the first housing portion such that the electronic device exhibits a substantially uniform overall thickness measured perpendicular to the first surface.

3. The electronic device of claim 2, wherein a thickness of the protruding portion measured perpendicular to the first surface substantially equals a combined thickness of the flat portion and the first housing portion.

4. The electronic device of claim 2, wherein the protruding portion further comprises a plate covering at least a portion of the speaker housing and concealing one or more buttons disposed beneath the plate.

5. The electronic device of claim 4, wherein the plate defines a plurality of acoustic openings to facilitate acoustic output from the speaker unit, and is further configured as an interactive input structure for the one or more buttons disposed beneath the plate.

6. The electronic device of claim 4, wherein the plate is pivotably mounted to the protruding portion about a fixed shaft disposed between a first subregion and a second subregion of the plate, such that rotation of the plate about the fixed shaft toward the first subregion depresses a first button of the one or more buttons disposed beneath the first subregion, while lifting the plate away from a second button of the one or more buttons disposed beneath the second subregion, and rotation of the plate about the fixed shaft toward the second subregion depresses the second button while lifting away from the first button.

7. The electronic device of claim 1, wherein the first housing portion has a second surface opposite the first surface, and a display screen is disposed at the second surface.

8. The electronic device of claim 1, wherein the motorized rotating-shaft assembly comprises at least one electric motor operable by one or more processors, and the one or more processors are configured to execute instructions to:
in response to detecting, by the one or more processors based on image data captured by the at least one camera, an object of interest,
actuate the at least one electric motor to rotate at least one of the first and second housing portions about the folding axis so as to orient an optical axis of the at least one camera toward the object of interest.

9. The electronic device of claim 8, wherein the at least one electric motor of the motorized rotating-shaft assembly drives a first bracket and a second bracket disposed on opposite sides of the folding axis through a shaft extending between and operatively coupling the first bracket and the second bracket.

10. The electronic device of claim 1, further comprising at least one processor configured to determine a rotation angle of at least one of the first and second housing portions relative to the connector and to actuate the motorized rotating-shaft assembly to position at least one of the first and second housing portions at a desired angle about the folding axis.

11. The electronic device of claim 10, wherein the at least one processor is configured to, in response to determining that the at least one camera is physically occluded in the folded configuration, disable image capture by the at least one camera.

12. The electronic device of claim 1, wherein:
the first housing portion is rotatable relative to the connector about a first axis of rotation; and
the second housing portion is rotatable relative to the connector about a second axis of rotation,
wherein the first axis of rotation and the second axis of rotation are spaced apart and substantially parallel to the folding axis.

13. The electronic device of claim 1, wherein the motorized rotating-shaft assembly comprises:
a transmission operatively coupled to the housing, the transmission comprising:
a first transmission assembly including a first plurality of gears; and
a second transmission assembly including a second plurality of gears; and
at least one electric motor operatively coupled to the transmission to deliver drive power to the first and second housing portions through the transmission, the motorized rotating-shaft assembly defining a first axis of rotation and a second axis of rotation each extending between the first and second transmission assemblies.

14. The electronic device of claim 1, wherein the first housing portion comprises an array of LED strips disposed at the first surface and arranged around the at least one camera, the LED strips being configured to provide illumination for the at least one camera.

15. The electronic device of claim 1, further comprising a support bracket detachably coupled to a rear surface of the second housing portion and configured to receive and retain an accessory, the support bracket defining a through-hole configured to receive the accessory.

16. The electronic device of claim 1, further comprising:
a gyroscope; and
at least one processor configured to adjust image stabilization parameters of the at least one camera based on signals from the gyroscope during image capture.

17. The electronic device of claim 1, further comprising:
a memory storing a set of discrete desired angles about the folding axis; and
at least one processor configured to actuate the motorized rotating-shaft assembly to position the first and second housing portions at a selected one of the discrete desired angles.

18. A method of operating an electronic device having a housing with first and second housing portions and a connector having a motorized rotating-shaft assembly, the method comprising:
capturing, by at least one camera disposed at a first surface of the first housing portion, image data; and
actuating the motorized rotating-shaft assembly to rotate at least one of the first housing portion or the second housing portion about a folding axis between an unfolded configuration and a folded configuration, wherein in the folded configuration, an imaging aperture of the at least one camera is physically occluded with the second housing portion.

19. The method of claim 18, wherein actuating the motorized rotating-shaft assembly comprises:
in response to detecting, by one or more processors based on image data captured by the at least one camera, an object of interest, actuating at least one electric motor of the motorized rotating-shaft assembly to rotate at least one of the first housing portion or the second housing portion about the folding axis to orient an optical axis of the at least one camera toward the object of interest.:

20. The method of claim 18, wherein the motorized rotating-shaft assembly comprises a dual-axis motorized rotating-shaft assembly, the method further comprising:
selecting, by one or more processors, a desired angle from a set of discrete desired angles about the folding axis; and
actuating the dual-axis motorized rotating-shaft assembly to position the first and second housing portions at the selected desired angle.
